(19) United States
(12) Patent Application Publication
(10) Pub. No.: US 2026/0236441 A1
(43) Pub. Date: Aug. 13, 2026

(54) SYSTEMS AND METHODS FOR CONSTRUCTING TOTAL SCHEMA IN DYNAMIC SCHEMA DATABASES

(71) Applicant: MongoDB, Inc., New York, NY (US)

(72) Inventor: Nathan Leniz, New York, NY (US)

(73) Assignee: MongoDB, Inc., New York, NY (US)

(21) Appl. No.: 19/530,688

(22) Filed: Feb. 5, 2026

Related U.S. Application Data
(60) Provisional application No. 63/755,805, filed on Feb. 7, 2025.

(51) Int. Cl. G06F 16/21; G06F 16/2455

(52) U.S. Cl. CPC G06F 16/213; G06F 16/24554

(57) ABSTRACT

A system for generating a schema representation in a dynamic schema database is provided. At least one processor is configured to identify an initial schema for a target grouping of source data and execute a query to identify source data documents not matching the initial schema. The at least one processor captures attributes from non-matching documents and generates an updated schema by performing a union operation of the initial schema and captured attributes. The at least one processor iteratively re-executes the query to identify documents not matching the updated schema and updates the schema based on attributes from non-matching documents. The at least one processor validates the updated schema when no results are returned from a query identifying non-matching documents.

### RELATED APPLICATIONS

This application claims priority under 35 U.S.C. § 119 (e) to U.S. Provisional Application Ser. No. 63/755,805, entitled “SYSTEMS AND METHODS FOR CONSTRUCTING TOTAL SCHEMA IN DYNAMIC SCHEMA DATABASES,” filed on Feb. 7, 2025, which is herein incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Knowing the architecture of data is valuable in context of analytics and database management as well as in a host of other functionalities. For relational databases, understanding data architecture can be reduced to a well-defined schema and enforcement of those schema properties. In a non-relational or dynamic schema database the ability to know data architecture is far more challenging as the data is subject to change over time, and typically there are no limits via data validation or structure constraints. Conventional solutions to this problem involve sampling data to create an approximate understanding of data architecture.

### SUMMARY

The inventors have realized that there is an opportunity to build total schemas even in the dynamic schema settings, and limit the computational burden of prior sampling approaches, improving both the accuracy of a constructed schema and/or the operational efficiency of the database over conventional approaches. A total schema system can include a variety of components to facilitate operations that generate a schema for a dynamic schema database. Various examples are implemented without requiring the sampling operations that would result in a representative or approximate schema. One of the challenges in conventional approaches is the need for sampling that can be computationally burdensome, and even require sampling of every document in a database to build an accurate representation. It should be understood that a sampling that requires evaluation of every data source is not useful and should not be used.

According to some embodiments, the system can include a schema builder component as well as an interface for accessing the schema builder functionality. The interface can also facilitate operations that employ any generated schema, for example, to improve the execution of other database operations. The schema builder can be configured to iteratively query a data source of dynamic or no schema data (e.g., organized as document-based data, among other options). References to dynamic schema can include dynamic schema data, no schema data, no enforced schema data, and/or non-relational data. The queries are specially configured to identify source data (e.g., documents) having properties that need to be added to a total schema. In some examples, the system leverages a seed schema or an initial schema to construct queries that return data sources not matching a current schema. For example, the queries can be tailored to identify data that does not match the initial or seed schema. The initial schema can then be updated based on the non-matching results. In other embodiments, the updated schema is then used for further queries to identify data not matching the updated schema, which can be used for further updates. The approach can be iterated until no non-matching results are returned or until a threshold is reached (discussed in greater detail herein). In further embodiments, command line functions can leverage the constructed total schema, enable definition of thresholds for schema building, store schema information on a collection basis, store schema information on a view basis, as well as provide access to other or controlling schema building functions discussed in greater detail herein.

According to one aspect, a system for generating a schema representation in a dynamic schema database, the system comprising at least one processor operatively connected to a memory, the at least one processor when executing configured to identify any initial schema (e.g., pre-defined, sampled, or user submitted), trigger a query operation to identify source data (e.g., documents) not matching the initial schema, capture attributes from the documents not matching the initial schema, generate a union of the initial schema and the attributes to generate an updated schema, re-execute the query operation to identify source data (e.g., documents) not matching the updated version of a schema, and validating the updated schema based on no results returned on a query operation to identify documents not matching the updated schema.

According to one embodiment, the at least one processor is further configured to generate a set similarity index score based on an intersection of keys in two documents divided by a union of keys in the two documents, and manage execution of schema operations using a threshold value for the set similarity index score to prevent runaway querying. According to one embodiment, the at least one processor is further configured to determine that documents are a subset or superset of each other and treat the documents as identical for purposes of the set similarity index score calculation. According to one embodiment, the at least one processor is further configured to ignore the set similarity index score for a predetermined number of initial iterations of the query operation. According to one embodiment, the at least one processor is further configured to partition the target grouping of source data into a plurality of partitions and execute the query operation in parallel across the plurality of partitions.

According to one embodiment, the at least one processor is further configured to union schema results from each partition of the plurality of partitions to produce a complete schema for the target grouping. According to one embodiment, the at least one processor is further configured to generate a schema on views of source data having a dynamic schema architecture by sampling a source collection and executing a view pipeline against sampled documents. According to one embodiment, the union operation is additive for properties such that new fields discovered in non-matching documents are added to the schema, and reductive for required fields such that fields not appearing in every document are removed from a required set while remaining in a properties definition.

According to one embodiment, the at least one processor is further configured to execute the query operation using a $jsonSchema query operator with a negation condition to find documents having properties not represented in a current schema definition. According to one embodiment, the initial schema comprises at least one of a pre-defined schema, a sampled schema, or a user-submitted schema.

According to one aspect, a computer implemented method for generating a schema representation in a dynamic schema database, the method comprises identifying, by at least one processor, any initial schema (e.g., pre-defined, sampled, or user submitted), triggering a query operation to identify source data (e.g., documents) not matching the initial schema, capture attributes from the documents not matching the initial schema and generate a union of the initial schema and the attributes, re-execute the query operation to identify source data (e.g., documents) not matching an updated version of a schema, and validating the updated schema based on no results returned on a recent query operation to identify documents not matching the updated schema.

According to one embodiment, comprising generating a set similarity index score based on an intersection of keys in two documents divided by a union of keys in the two documents, and managing execution of schema operations using a threshold value for the set similarity index score to prevent runaway querying. According to one embodiment, comprising determining that documents are a subset or superset of each other and treating the documents as identical for purposes of the set similarity index score calculation. According to one embodiment, comprising partitioning the target grouping of source data into a plurality of partitions and executing the query operation in parallel across the plurality of partitions. According to one embodiment, comprising unioning schema results from each partition of the plurality of partitions to produce a complete schema for the target grouping.

According to one embodiment, the union operation is additive for properties such that new fields discovered in non-matching documents are added to the schema, and reductive for required fields such that fields not appearing in every document are removed from a required set while remaining in a properties definition. According to one aspect, a non-transitory computer-readable storage medium storing processor-executable instructions that, when executed by at least one processor, cause the at least one processor to perform operations for generating a schema representation in a dynamic schema database, the operations comprising identifying an initial schema for a target grouping of source data in the dynamic schema database, executing a query operation configured to identify source data documents not matching the initial schema, capturing attributes from the source data documents not matching the initial schema, generating an updated schema by performing a union operation of the initial schema and the captured attributes, iteratively re-executing the query operation to identify source data documents not matching the updated schema and updating the schema based on attributes captured from non-matching documents, and validating the updated schema based on a determination that no results are returned from a query operation to identify documents not matching the updated schema.

According to one embodiment, the operations further comprise generating a set similarity index score based on an intersection of keys in two documents divided by a union of keys in the two documents, and managing execution of schema operations using a threshold value for the set similarity index score to prevent runaway querying. According to one embodiment, the operations further comprise determining that documents are a subset or superset of each other and treating the documents as identical for purposes of the set similarity index score calculation. According to one embodiment, the operations further comprise partitioning the target grouping of source data into a plurality of partitions and executing the query operation in parallel across the plurality of partitions.

According to one aspect, a system for using a total schema defined on a dynamic schema database, comprises at least one processor operatively connected to a memory, the at least one processor when executing access a validated total schema, the validation including a similarity analysis evaluating a target grouping of source data comprising dynamic schema data against a schema for the target, and execute a structured query operation on a dynamic schema source under strongly typed execution parameters, wherein the execution includes use of the validated total schema to enable strongly typed execution of the structured query operation.

According to one embodiment, the similarity analysis comprises computing a Jaccard index based on an intersection of keys in source data documents divided by a union of keys in the source data documents. According to one embodiment, the at least one processor is further configured to determine that the validated total schema is unstable when the Jaccard index falls below a stability threshold value after a predetermined number of union operations. According to one embodiment, the validated total schema is generated through an iterative process comprised querying the target grouping to identify source data documents not matching a current schema, extracting attributes from the source data documents not matching the current schema, and updating the current schema by performing a union operation using the extracted attributes. According to one embodiment, the strongly typed execution parameters comprise type definitions for fields in the dynamic schema source derived from the validated total schema.

According to one embodiment, the dynamic schema source comprises a document-based database, and wherein the validated total schema comprises a jsonSchema representation specifying field types and required fields for documents in the target grouping. According to one aspect, a computer implemented method for using a total schema defined on a dynamic schema database, comprise accessing, by at least one processor, a validated total schema, the validation including a similarity analysis evaluating a target grouping of source data comprising dynamic schema data against a schema for the target grouping, and executing, by the at least one processor, a structured query operation on a dynamic schema source under strongly typed execution parameters, wherein the execution includes use of the validated total schema to enable the strongly typed execution of the structured query operation.

According to one embodiment, the similarity analysis comprises computing a Jaccard index based on an intersection of keys in source data documents divided by a union of keys in the source data documents. According to one embodiment, comprising determining that the validated total schema is unstable when the Jaccard index falls below a stability threshold value after a predetermined number of union operations. According to one embodiment, the predetermined number of union operations is at least five union operations. According to one embodiment, the validated total schema is generated through an iterative process comprises querying the target grouping to identify source data documents not matching a current schema extracting attributes from the source data documents not matching the current schema, and updating the current schema by performing a union operation using the extracted attributes. According to one embodiment, the union operation is additive for properties and reductive for required fields. According to one embodiment, the strongly typed execution parameters comprise type definitions for fields in the dynamic schema source derived from the validated total schema.

According to one embodiment, the dynamic schema source comprises a document-based database, and wherein the validated total schema comprises a jsonSchema representation specifying field types and required fields for documents in the target grouping. According to one aspect, a non-transitory computer-readable medium storing instructions which, when executed by at least one processor, cause the at least one processor to perform operations comprising accessing a validated total schema, the validation including a similarity analysis evaluating a target grouping of source data comprising dynamic schema data against a schema for the target grouping, and executing a structured query operation on a dynamic schema source under strongly typed execution parameters, wherein the execution includes use of the validated total schema to enable strongly typed execution of the structured query operation. According to one embodiment, the similarity analysis comprises computing a Jaccard index based on an intersection of keys in source data documents divided by a union of keys in the source data documents.

According to one embodiment, the operations further comprise determining that the validated total schema is unstable when the Jaccard index falls below a stability threshold value after a predetermined number of union operations. According to one embodiment, the validated total schema is generated through an iterative process comprises querying the target grouping to identify source data documents not matching a current schema, extracting attributes from the source data documents not matching the current schema, and updating the current schema by performing a union operation using the extracted attributes. According to one embodiment, the union operation is additive for properties and reductive for required fields. According to one embodiment, the dynamic schema source comprises a document-based database, and wherein the validated total schema comprises a jsonSchema representation specifying field types and required fields for documents in the target grouping.

According to one aspect, a user interface for managing construction and definition of a total schema in a dynamic schema database, the user interface instantiated by at least one processor, and configured to accept an instruction to build a schema specifying at least a target comprising a grouping of source dynamic schema data, evaluate any arguments and options included with the instruction to build the schema, execute the instruction against the grouping of source data, wherein the execution is tailored based on any argument or option, including operations to resolve default execution against overriding arguments or options, wherein in response to execution of the instruction query using a current schema against the target and identify non-matching source data, extract attributes from the non-matching source data, update the current schema using the attributes and an initial schema, and repeat the querying, extracting, and updating until a threshold for schema creation is met, and store a final schema associated with the target satisfying the threshold for schema creation.

According to one embodiment, the threshold for schema creation comprises one of: no non-matching source data returned from the query, a maximum number of query iterations executed, a maximum number of returned non-matching results, or a set similarity index score falling below a stability threshold value. According to one embodiment, the arguments and options include at least one of: an include list specifying namespaces to analyze, an exclude list specifying namespaces to ignore, a dry run flag for outputting a list of targets without performing schema analysis, or a schema collection name for storing schema information. According to one embodiment, the at least one processor is further configured to filter the grouping of source dynamic schema data based on the include list and the exclude list prior to executing the instruction, and wherein the filtering excludes system collections specified in a disallowed collection names array.

According to one embodiment, updating the current schema comprises performing a union operation that is additive for properties and reductive for required fields, such that new fields discovered in non-matching source data are added to the current schema while fields that do not appear in every document are removed from a required set. According to one embodiment, the at least one processor is further configured to generate a set similarity index score based on a Jaccard index that defines an intersection of keys in two documents divided by a union of keys in the two documents, and to terminate the querying, extracting, and updating when the set similarity index score falls below a stability threshold value. According to one embodiment, the at least one processor is configured to ignore the set similarity index score for an initial number of iterations of the querying, extracting, and updating, and to apply the stability threshold value after the initial number of iterations has been completed.

According to one aspect, a system for managing construction and definition of a total schema in a dynamic schema database, the system comprises at least one processor operatively connected to a memory, the at least one processor when executing configured to accept an instruction to build a schema specifying at least a target comprising a grouping of source dynamic schema data, evaluate any arguments and options included with the instruction to build the schema, execute the instruction against the grouping of source data, wherein the execution is tailored based on any argument or option, including operations to resolve default execution against overriding arguments or options, wherein in response to execution of the instruction query using a current schema against the target and identify non-matching source data, extract attributes from the non-matching source data, update an initial schema using the attributes and the initial schema, and repeat the querying, extracting, and updating until a threshold for schema creation is met, and store a final schema associated with the target satisfying the threshold for schema creation.

According to one embodiment, the threshold for schema creation comprises one of: no non-matching source data returned from the query, a maximum number of query iterations executed, a maximum number of returned non-matching results, or a set similarity index score falling below a stability threshold value. According to one embodiment, the arguments and options include at least one of: an include list specifying namespaces to analyze, an exclude list specifying namespaces to ignore, a dry run flag for outputting a list of targets without performing schema analysis, or a schema collection name for storing schema information. According to one embodiment, the at least one processor is further configured to filter the grouping of source dynamic schema data based on the include list and the exclude list prior to executing the instruction, and wherein the filtering excludes system collections specified in a disallowed collection names array.

According to one embodiment, updating the initial schema comprises performing a union operation that is additive for properties and reductive for required fields, such that new fields discovered in non-matching source data are added to the initial schema while fields that do not appear in every document are removed from a required set. According to one embodiment, the at least one processor is further configured to partition the grouping of source dynamic schema data into chunks based on a partition size threshold, and to process each chunk in parallel using asynchronous tasks to derive a schema for each chunk. According to one embodiment, the at least one processor is further configured to union the schemas derived from each chunk to produce the final schema associated with the target. According to one embodiment, the at least one processor is further configured to generate a set similarity index score based on a Jaccard index and to terminate the querying, extracting, and updating when the set similarity index score falls below a stability threshold value after an initial number of iterations has been completed.

According to one aspect, a computer implemented method for managing construction and definition of a total schema in a dynamic schema database, the method comprises accepting, by at least one processor, an instruction to build a schema specifying at least a target comprising a grouping of source dynamic schema data, evaluating, by the at least one processor, any arguments and options included with the instruction to build the schema, executing, by the at least one processor, the instruction against the grouping of source data, wherein the execution is tailored based on any argument or option, including operations to resolve default execution against overriding arguments or options, wherein executing includes querying using a current schema against the target and identifying non-matching source data, extracting attributes from the non-matching source data, updating an initial schema using the attributes and the initial schema, and repeating the querying, extracting, and updating until a threshold for schema creation is met, and storing a final schema associated with the target satisfying the threshold for schema creation.

According to one embodiment, the threshold for schema creation comprises one of: no non-matching source data returned from the query, a maximum number of query iterations executed, a maximum number of returned non-matching results, or a set similarity index score falling below a stability threshold value. According to one embodiment, updating the initial schema comprises performing a union operation that is additive for properties and reductive for required fields, such that new fields discovered in non-matching source data are added to the initial schema while fields that do not appear in every document are removed from a required set. According to one embodiment, comprising generating a set similarity index score based on a Jaccard index that defines an intersection of keys in two documents divided by a union of keys in the two documents, and terminating the querying, extracting, and updating when the set similarity index score falls below a stability threshold value after an initial number of iterations has been completed.

According to one embodiment, comprising partitioning the grouping of source dynamic schema data into chunks based on a partition size threshold, processing each chunk in parallel using asynchronous tasks to derive a schema for each chunk, and unioning the schemas derived from each chunk to produce the final schema associated with the target.

According to one aspect, a interface for managing construction and definition of a total schema in a dynamic schema database, the user interface instantiated by at least one processor, and configured to accept an instruction to build a schema specifying at least a target comprising a grouping of source dynamic schema data (e.g., collection), evaluate any arguments and/or options included with the instructions to build the schema, execute the instruction against the grouping of source data (e.g., collection), wherein the execution is tailored based on any argument or option, including operations to resolve default execution against overriding arguments or options wherein in response to execution of the instruction: (A) query using a current schema against the target and identify non-matching source data; (B) extract attributes from the non-matching source data; and (C) update the current schema (e.g., based on a union operation) using the attributes and the initial schema; and (D) repeat A-C until a threshold for schema creation (e.g., number of documents, number of queries, similarity threshold, etc.) is met; and store a final schema associated with the target satisfying the threshold for schema creation.

According to one embodiment, the threshold for schema creation comprises one of: no non-matching source data returned from the query, a maximum number of query iterations executed, a maximum number of return non-matching results, or a set similarity index score falling below a stability threshold value. According to one embodiment, the arguments and options include at least one of: an include list specifying namespaces to analyze, an exclude list specifying namespaces to ignore, a dry run flag for outputting a list of targets without performing schema analysis, or a schema collection name for storing schema information. According to one embodiment, the at least one processor is further configured to filter the grouping of source dynamic schema data based on the include list and the exclude list prior to executing the instruction, and wherein the filtering excludes system collections specified in a disallowed collection names array.

According to one aspect, a system for managing construction and definition of a total schema in a dynamic schema database, the system comprises at least one processor operatively connected to a memory, the at least one processor when executing configured to accept an instruction to build a schema specifying at least a target comprising a grouping of source dynamic schema data (e.g., collection), evaluate any arguments and/or options included with the instructions to build the schema, execute the instruction against the grouping of source data (e.g., collection), wherein the execution is tailored based on any argument or option, including operations to resolve default execution against overriding arguments or options, wherein in response to execution of the instruction: (A) query using a current schema against the target and identify non-matching source data; (B) extract attributes from the non-matching source data; and (C) update the initial schema (e.g., based on a union operation) using the attributes and the initial schema; and (D) repeat A-C until a threshold for schema creation (e.g., number of documents, number of queries, similarity threshold, etc.) is met; and store a final schema associated with the target satisfying the threshold for schema creation.

According to one embodiment, the threshold for schema creation comprises one of: no non-matching source data returned from the query, a maximum number of query iterations executed, a maximum number of return non-matching results, or a set similarity index score falling below a stability threshold value. According to one embodiment, the arguments and options include at least one of: an include list specifying namespaces to analyze, an exclude list specifying namespaces to ignore, a dry run flag for outputting a list of targets without performing schema analysis, or a schema collection name for storing schema information. According to one embodiment, the at least one processor is further configured to filter the grouping of source dynamic schema data based on the include list and the exclude list prior to executing the instruction, and wherein the filtering excludes system collections specified in a disallowed collection names array. According to one aspect, a computer implemented method for managing construction and definition of a total schema in a dynamic schema database, the method comprises accepting, by at least one processor, an instruction to build a schema specifying at least a target comprising a grouping of source dynamic schema data (e.g., collection), evaluating, by the at least one processor, any arguments and/or options included with the instructions to build the schema, executing, by the at least one processor, the instruction against the grouping of source data (e.g., collection), wherein the execution is tailored based on any argument or option, including operations to resolve default execution against overriding arguments or options, wherein executing includes: (A) querying using a current schema against the target and identify non-matching source data; (B) extract attributes from the non-matching source data; and (C) update the initial schema (e.g., based on a union operation) using the attributes and the initial schema; and (D) repeat A-C until a threshold for schema creation (e.g., number of documents, number of queries, similarity threshold, etc.) is met; and store a final schema associated with the target satisfying the threshold for schema creation.

According to one embodiment, the at least one processor is configured to generate a custom set similarity index score and manage execution of schema operations using a threshold value for custom set similarity index score to prevent runaway querying. According to one embodiment, the at least one processor is configured to generate a schema on views of source data having a dynamic schema architecture.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 illustrates a block diagram of a total schema system configured for schema building in dynamic schema databases, according to one embodiment;

FIG. 2 is a block diagram of an example computer system improved by implementation of the functions, operations, and/or architectures described herein;

FIG. 3 illustrates a block diagram of a schema generation system configured for generating and validating schemas, according to an embodiment;

FIG. 4 illustrates a block diagram of a dynamic schema database system configured to generate and manage schema representations, according to one embodiment;

FIG. 5 illustrates a sequence diagram representing a total schema generation process for a dynamic schema database, according to an embodiment;

FIG. 6 illustrates a block diagram of a total schema execution system configured for using a total schema defined on a dynamic schema database, according to aspects of the present disclosure;

FIGS. 7A-B illustrate a sequence diagram representing a process for using a total schema defined on a dynamic schema database, according to an embodiment;

FIG. 8 illustrates a block diagram of a user interface system configured for managing construction and definition of a total schema, according to one embodiment; and

FIGS. 9A-B illustrate a sequence diagram representing a schema construction process for managing construction and definition of a total schema in a dynamic schema database, according to an embodiment.

### DETAILED DESCRIPTION

According to some aspects, a total schema system is provided. The system is configured to build a total schema for dynamic schema data, provide an interface for accessing and controlling schema building functions, as well as to provide interfaces that enable native database operations to utilize the construction of the schema, improving database efficiency, among other operational advantages. The system can implement an iterative query approach to identify source data not within an existing schema definition. Once identified, properties from that data can be integrated into a schema definition. Such schemas can be built for organizations of source data (e.g., collections (named groupings of source data), views of source data, among other options). In one example, a collection or other logical grouping can be queried to identify any source data not matching a schema definition. The non-matching data is used to update the schema definition for the collection. A similar approach can be executed on database views, discussed in greater detail below. Various embodiments include safeguards to ensure query execution and schema updates do not overwhelm or even consume inappropriate amounts of resources, as discussed in greater detail below. Various example implementation of respective functions, calls, options, and variables, among other implementations, are described that highlight functionality that can be implemented in dynamic schema database implementation. The examples focus on MongoDB, document-based data units, and collections as logical groupings of documents; however, other embodiments implement the functions and operations with other dynamic schema data units and other logical groupings of such data units. Additional examples of functionality and operations are described that can be implemented in the various embodiments disclosed.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

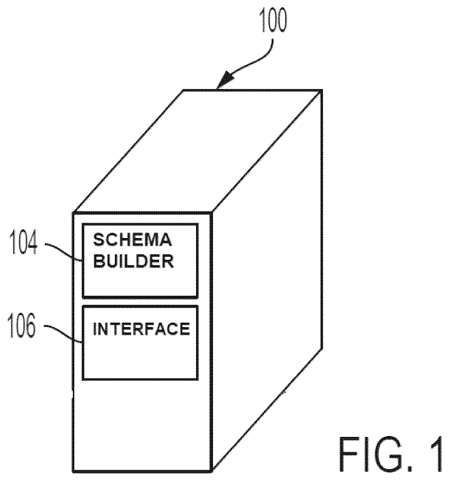

FIG. 1 illustrates elements of a total schema system that provides schema building and/or interfaces to schema construction functions. The illustrated elements can be integrated into a dynamic schema database deployment, including, for example, the well-known MONGODB architecture. As shown the elements of the total schema system can include a schema builder component 104 configured to manage schema construction, for example, via iterative query and schema update operations. The elements can also include an interface component 106 configured to enable administrator users or database users to access and/or manage schema builder functionality. In some examples, the interface 106 is configured to define, accept, and execute command line instructions for schema builder functions. The interface 106 can include a command line interface (CLI) that can be configured to accept arguments and options that control and/or alter execution of the schema builder functions, among other options.

### Implementation Examples: Schema Builder

Various functions of a schema builder component include computation of the schema, which can be done for every collection and database view in every database instance in a timely manner. The schema builder component can be instantiated by or as part of a schema builder system and/or as part distributed database system. In some examples, the schema builder can provide operations for a distributed database where a total schema can be created on dynamic schema source data. The operations can be controlled by the user via include/exclude definition or allow/disallow lists, among other examples. Thes system can execute a schema-computation algorithm described via examples below, which produces a complete schema of all collections/views examined. Further operations can be configured to provide status updates (discussed below) as actions occur. In other embodiments, other groupings of dynamic schema data may be used and analyze to generate total schemas.

At a high level, various embodiments of a schema builder provide a repeated query machine that computes a total schema by iteratively analyzing subsets of source data units (e.g., documents) from each of a user's defined namespaces (e.g., collections of documents or other logical organizations of data). Various embodiments can execute, for example, a $jsonScema query operator and tailor the query to find documents that do not match an existing, computed schema, or defined schema. Each iteration of the query operates by analyzing fewer and fewer documents as new properties are added to the schema. During execution the system repeatedly performs the query and update schema action until no documents are returned or a threshold (e.g., number of documents, number of queries, similarity threshold, etc.) is reached. The results in much greater performance and accuracy (over conventional approaches) and more specifically, over previous versions of schema computation that rely on sampling. According to some embodiments, builder operations can be executed as asynchronous for I/O operations and can leverage multiple CPU cores for processing.

### Example Public Application Programming Interface (API)

According to one embodiment, an entry-point of the schema builder and/or schema builder library is a public build_schemafunction. This function can be called via a command line interface or via other interface access. According to one embodiment, the function is configured to accept MongoDB connection options and several channels for communicating with the caller. According to further embodiments, the function returns nothing-output is sent over the provided channels.

The schema builder can implement various functions including an alternative implementation discussed below. Additional changes to the public API cam include a tokio::Runtime argument, and a BuilderOptions struct that contains information for inclusion/exclusion of namespaces, the dry_run flag, and the schema collection the schema builder library should query for schema information. Tokio is a known runtime library for an asynchronous execution in the RUST programming language. If the schema collection argument is None, the builder will not attempt to persist or update the schema, making it compatible with other tools such as the TRR. Example code for a MONDODB client is provided to illustrate:

```
Unset
  pub struct BuilderOptions<′a> {
    /// The namespaces to include pub include: &′a Vec<String>,
    /// The namespaces to exclude pub exclude: &′a Vec<String>,
    /// The name of the schema collection
  pub schema_collection: &′a Option<String>,
    /// Whether to perform a dry run, i.e. no analysis and no writing to the database
  pub dry_run: bool,
    /// The MongoDB client
  pub client: &′a mongodb::Client,
    /// The notification channel pub tx_notifications:
  Option<tokio::sync::mpsc::UnboundedSender<SamplerNotification>>,
    /// The schema channel pub tx_schemata:
  tokio::sync::mpsc::UnboundedSender<Result<crate::SchemaResult>>,
  }
```

### Example Functions: Inclusion And Exclusion of Database and/or Collections

According to various embodiments, the builder component has a mechanism to ignore system collections that should not be analyzed. Further implementation includes the ability to only include a subset of databases and/or collections, as well as the ability to ignore a subset of databases and/or collections in addition to the default ignored system namespaces. The databases and collections ignored by default can be specified as follows:

```
Unset
    // ignored if matches
  pub const DISALLOWED_DB_NAMES: [&str; 4] = [“admin”, “config”, “local”, “system”];
  // ignored if starts_with
  pub const DISALLOWED_COLLECTION_NAMES: [&str; 2] = [“system”];
```

Inclusion/exclusion can be specified (e.g., use glob or exact enumeration to match namespaces that should be included or excluded). If include is Some, namespaces will be tested if they match any includeelements. Then, if excludeis Some, they will be tested to see if they match any exclude elements. Lastly, they will be tested against the DISALLOWED_DB_NAMES and DISALLOWED_COLLECTION_NAMES arrays. This will happen in a streaming fashion for each element in the database and collection list. The collection name provided (e.g., in BuilderOptions) will be added to disallowed collection names as it is not envisioned that a schema for schemas will be necessary. Any namespaces that have not been filtered out will then be used for further analysis.

If a user specifies the dry_run option to the CLI, the system/builder is configured to output a list of collections/views it would have built a schema for and perform no further analysis. This visualization will aid users in turning their inclusion and exclusion lists.

### Example Schema Execution for Source Data Grouping (e.g., Collection)

According to some embodiments, the schema functions can identify and leverage existing schema information (e.g., partial or sampled schema data, among other options). For example, the builder is configured to fetch an initial schema for each collection/view it encounters if the schema_collection Option in SchemaBuilderis Some value. Stated generally, the system identifies any definition of schema information for existing collections of data. The preceding examples highlight options and/or data storage for schema information and retrieval. Other options can be used, including searching for schema data/metadata on other data groupings in other dynamic schema databases to identify initial schema information. Initial schema information benefits the user by speeding up operations as most documents in the collection will already match this existing schema.

In various implementations, the choice for the builder to perform this operation is one of practicality. For example, if the caller was responsible for providing the initial schema documents, the caller would have to initially query the_sql_schemas collection in each database, store the schemas in memory, and send a struct containing all database schemas to the builder. This operation in such an execution would essentially mirror what the builder already does during the initial phase of schema computation when enumerating all databases and collections/views.

### Example Function: Collection Partitioning

According to some embodiments, a schema building function/process can partition data groups to improve processing and efficiency. For example, according to one embodiment, collections are partitioned into 100 MB chunks. In other examples, different partition sizes can be used or approximate size thresholds can be used. According to one embodiment, existing functions in a distributed database can be executed to determine a minimum bound. In a MongoDB environment, the minimum bound within each chunk is found by using a $bucketAuto stage that groups on the_idfield. If collections are <=100 MB the partition operation is skipped and instead the entire collection is considered one partition. In other embodiments, the partition size limit can be based on operational defaults of a respective database management system or settings made on respective database systems.

Note that the example 100 MB limit comes from the MongoDB server example.

### Example Function: Querying

In further embodiments, the schema builder or process can be configured to trigger a parallel work framework to process after defining the partitions. In one example, the process determines:

1. If there is an Initial Schema
The initial schema is used as the “seed” for the partition.
   2. If there is No Initial Schema
An aggregation operation is issued that sorts based on the_id and limits the result set to 20 documents—in other examples, different numbers of documents are used 15, 20, 25, 20, etc. In further embodiments, the schema for these select number of documents is computed and “seeds” the schema for the partition.

In still other embodiments, the builder is configured to execute a loop where it repeatedly issues query operations for documents that do not match the computed schema. The schema for each resulting document is calculated and merged with the existing schema, resulting in a new schema that meets all encountered documents so far. This operation repeats until there are no more results within the partition. According to one example, the results of each partition are unioned together to produce the schema of the entire collection.

In further example, a schema can be computed for each document by determining the jsonSchema for that the document or other data unit. For example, if an object (e.g., document) has 3 fields (a, b, c) and looks like the following:

```
{
  a: “value”,
  b: true,
  c: 75
}
```

The document and values are examined to create a jsonSchema representation.

```
{
  “type”: “object”,
  “properties”: {
      “a”: {
        “type”: “string”
      },
    “b”: {
      “type”: “boolean”
    },
    “c”: {
      “type”: “number”
    }
  },
  “required”: [“a”, “b”, “c”],
  “additionalProperties”: false
}
```

Given two documents with differing schemas (e.g., documents with identical schemas result in no schema change):

```
{
    a: “value”,
    b: true,
    c: 75
}
{
    b: true,
    c: 112,
    d: “a”
}
// the schema union between these two is:
{
  “type”: “object”,
  “properties”: {
    “a”: {
      “type”: “string”
    },
    “b”: {
      “type”: “boolean”
    },
    “c”: {
      “type”: “number”
    },
    “d”: {
      “type”: “string”
    }
  },
  “required”: [“b”, “c”],
  “additionalProperties”: false
}
```

Accordingly, this new union schema can be used to capture or match on both documents above. According to various implementations, fields “a” and “d” are not required, since they do not appear in every document. However, the properties of their potential fields and what they must conform to can be reflected. Schema unioning is implemented as additive for properties and reductive for required data in the event of new/different elements being captured.

### Example Function: Jaccard Index

According to various embodiments, the builder functions are configured to limit the extent of queries that will execute during schema building. For example, the inventors have realized that documents that are wildly different (for example, documents with 100 unique keys each) would cause the query operation to essentially query for every document in the collection.

To avoid run-away query execution, various embodiments are configured to execute a set similarity analysis via construction of a set similarity index. For example, a Jaccard index can be built that defines the intersection of the keys in two documents divided by the union of two keys. Stated more generally, a Jaccard index is a measure (e.g., statistic) used for gauging the similarity and diversity of sample sets. It is defined in general by taking the ratio of two sizes (areas or volumes), the intersection size divided by the union size, also called intersection over union (IoU).

In further embodiments, the system is configured to ensure the similarity index doesn't change too rapidly. According to one example, documents that are a subset or superset are considered identical. The property allows schema growth that would be expected to happen naturally over time to avoid impacting the index. Additionally, the results of this property yields an easing effect so that the first iterations of schema computation are extremely tolerant of change. Further, the approach will gradually become less tolerant of change over time/iterations. In various implementations, the index can be ignored for initial iterations up to a threshold number (e.g., can be ignored entirely for the first 5 iterations (or 2, 2, 4, 6, etc.).

According to one example, data units (e.g., documents) are considered a strict subset or superset of each other if new/missing keys are entirely within either the lefthand side (lhs) or righthand side (rhs).

lhs: { a: “hi”, b: 3}
rhs: { a: “hello”, b: 5, c: true }

In the example above, Ihs is a subset of rhs, rhs is a superset of lhs.

In some implementations, Jaccard Indexes are created by the builder functions and do not impact schema computation/operations in the context of the database manager—e.g., for a mongosql-rs in a MongoDB database implementation. In various embodiments, the Jaccard index does not need to be stored as part of the schema.

### Example Function: Schema For Views

According to some embodiments, schema computation for views can be implemented differently than for collections. For example, the functionality is configured to handle the potential lack of an_id (e.g., present in partitions) that is permitted in the case of views. In other dynamic schema database other primary identification attributes can be used. The same consideration exists where views of data may not require such identification attributes. In a MongoDB implementation, the driving factor for treating views differently is the potential lack of an_id field that MongoDB allows for views but not for collections. In the MongoDB example, without the_idfield, there is no way to generate partitions in a stable manner that would be applicable to all view shapes. Some embodiments are implemented to ignore views. Other embodiments resolve the issues with the view as discussed below:

### Example Function: Determine Views

According to one embodiment, the system is configured to differentiate views from data collections. For example, in a MongoDB implementation views are separated from collections by modifying the list_collections native function and introducing a new helper function. The following code provides an example implementation:

```
  Unset
  #[derive(Debug,
  Default)] struct
  CollectionInfo {
    views:
    Vec<String>,
    collections:
    Vec<String>,
  }
  async fn list_collections_and_views(
    client: &Client,
    database: &str,
    tx_schemata: tokio::sync::mpsc::UnboundedSender<Result<SchemaAnalysis>>,
  ) -> CollectionInfo {
    let collection_info_cursor = client
      .database(database)
      .run_cursor_command(
        doc! { “listCollections”: 1.0, “authorizedCollections”: true,
  “nameOnly”: true},
        None,
      )
      .await
      .map_err(|e| async {
        tx_schemata.send(Err(e.into( ))).unwrap( );
      });
    let collection_info = match collection_info_cursor {
      Ok(collection_info) => separate_views_from_collections(collection_info)
        .await
        .unwrap( ),
      Err(_) => CollectionInfo::default( ),
    };
    drop(tx_schemata);
    collection_info
  }
  async fn
    separate_views_from_collection
    s( mut collection_doc:
    Cursor<Document>,
  ) -> Result<CollectionInfo> {
let mut collection_info = CollectionInfo::default( );
while let Some(collection_doc) = collection_doc.try_next( ).await.unwrap( ) { if
collection_doc
.get_str(“type”)
.expect(“Type expected in collection information document”)
== “view”
{
collection_info
.views
.push(collection_doc.get_str(“name”).unwrap( ).to_string( ));
} else {
collection_info
.collections
push(collection_doc.get_str(“name”).unwrap( ).to_string( ));
}
}
Ok(collection_info)
}
```

### Example Function: Querying

According to some embodiments, the builder function/process can be configured to process views differently. For example, unlike collections, which can be fully analyzed via the partition-method described above, the builder system is configured to process views by $sampling (a function that randomly selects a number of document) the source collection and executing the view pipeline. According to various embodiments, a sample size of 1000 will be used. In other examples, different sample sizes can be employed (e.g., 250, 500, 750, 1500, etc.).

Accordingly, the build schema function/process is configured to process views.

### Example Function: Results Hand Ling

As discussed, the public build_schemafunction does not provide a return. According to various embodiments, the public build schema function is configured to provides results to the caller by sending information over provided tokio channels. The tx_schemata channel sends SchemaAnalysis results.

```
/// An enum for communicating results of this library to a caller. Results may
/// be namespace-only, meaning they do not have to include schema information, or they
/// may include schema information.
#[derive(Debug, PartialEq)]
pub enum SchemaResult {
  /// SchemaResult without schema info. Used in dry_run mode.
  NamespaceOnly(NamespaceInfo),
  /// SchemaResult with schema info.
  FullSchema(NamespaceInfoWithSchema),
}
/// A struct representing namespace information for a view or collection.
#[derive(Debug, PartialEq)]
pub struct NamespaceInfo {
  /// The name of the database.
  pub db_name: String,
  /// The name of the collection or view which this schema represents.
  pub coll_or_view_name: String,
  /// The type of namespace (collection or view).
  pub namespace_type: NamespaceType,
}
/// A struct representing schema information for a specific namespace (a view
/// or collection).
#[derive(Debug, PartialEq)]
pub struct NamespaceInfoWithSchema {
  pub namespace_info: NamespaceInfo,
  /// The schema for the namespace.
  pub namespace_schema: Schema,
}
/// An enum representing the two namespace types for which this library
/// can generate schema: Collection and View.
#[derive(Debug, PartialEq)]
pub enum NamespaceType {
  Collection,
  View,
}
// end code
```

In various embodiments, the schema builder library uses this information to store the Schema in the database in jsonSchema format.

To facilitate execution, embodiments are configured to rename and modify the SchemaAnalysistype as follows:

```
Unset
  // The current SchemaAnalysis type. The first element is a database name.
  // The second element is a vector of single-value maps that map from
  // collection name to collection schema.
  pub type SchemaAnalysis = (String, Vec<HashMap<String, Schema>
  // The proposed new “SchemaAnalysis” type, renamed to SchemaResult. pub struct
SchemaResult {
  // The name of the database. db_name: String,
  // The name of the collection or view which this schema represents. coll_or_view_name:
String,
  // The type of namespace (collection or view) -- create an enum for this
  namespace_type: CollectionOrView,
  // The schema for the collection or view.coll_or_view_schema: mongosql::schema::Schema,
  }
```

Various embodiments are configured to notify when results are sent over tx_schemata. Currently, whenever a schema for a full database is completed, that database schema is sent over the communicate channel. In other examples, different communication channels can be used. In others, public build_schema can return such results. In further examples, the system is configured to send schema data sent over the channel whenever a collection or view schema is finished being built.

The function caller can use that information however needed. For example, the system can be configured (e.g., via a bic-trip call) to build a Map<String, Map<String, Schema>>that represents the complete cluster schema. The CLI can be configured to write the schema results to the database. It can do this asynchronously as results become available.

### Example Function: Notifications

According to various embodiments, the builder is capable of sending activity messages/notifications to the caller through the use of various communication (e.g., tokio) channels. Notifications are sent in the form of an action, as described in the example code below. Display is implemented as a convenience for the caller. A new action can be implemented for view processing.

Unset
#[derive(Debug, Clone)]
pub struct SchemaBuilderNotification { pub db: String,
pub collection_or_view: String, pub action: SchemaBuilderAction,
}
#[derive(Debug, Clone)]
pub enum SchemaBuilderAction { Querying { partition: u16 }, Processing { partition:
u16 }, Partitioning { partitions: u16 }, Error { message: String }, SamplingView,
}

### Querying Notifications

According to one embodiment, querying action messages are sent during the querying phase. They occur when the builder issues a call to the driver to find documents that do not match a schema.

### Processing Notifications

According to one embodiment, processing action messages are sent after a query returns, when the builder is performing the merge of two document schemas.

### Partitioning Notifications

According to one embodiment, partitioning action messages are sent when calculating the partitions for a collection.

### Error Notifications

According to one embodiment, Error action messages are sent whenever there is an error during builder operations, after the builder has begun work. Error action messages are not sent if there are initial errors, such as bad username/password or no primary found.

### Sampling View Notifications

According to one embodiment, Sampling View action messages are sent when the builder is sampling a view.

### Example Functions: Instrumentation and Logging

Instrumentation will be accomplished using a tracing function (e.g., tracing crate). Callers to the builder library will be responsible for capturing events and logging them, as appropriate. Functions are instrumented using the #[instrument] directive. The #[instrument] attribute provides addition of tracing spans to functions. A function annotated with #[instrument] creates and enters a span with that function's name when the function is called, with arguments to that function to be recorded as fields using fmt::Debug. Functions that are called repeatedly, such as derive_schema_for_partition, will be set at the TRACElevel. All other functions will be set at the DEBUGlevel.

According to various embodiments, derive_schema_for_partition is a callable function for iteratively finding documents that do not match, updating a schema definition for the partition as discussed herein. Further embodiments leverage parallel execution across virtual partitions of a collection under analysis and permit multiple thread to execute and speed up schema generation.

### Example Functions: Entry Point

Various embodiments leverage optimizations over the examples described. According to one example, function callers pass in mongodb::options::ClientOptions and the builder constructs a mongodb::Client to connect to the database. Other embodiments enables the builder to accept an already-created mongodb::Client, as well as BuilderOptions, for example specified in the CLI.

In one example, that includes following function signature for build_schema:
Unset
pub async fn build_schema<′a>(options: BuilderOptions<′_>)

Further embodiments optimize for concurrency and parallelism. Some embodiments relying on rely on two crates, rayon (a RUST library for parallel iterators) and tokio (an asynchronous runtime library for the RUST programming language) to implement embodiments of the schema builder. The rayon crate is useful for parallel execution, and the tokiocrate is useful for asynchronous execution, including the channels used for notifications. The inventors have realized that most of the schema builder tasks can be performed independently. Thus, each database can be operated upon independently-they do not impact each other. The same goes for each collection/view within a database. Even further, each partition of a collection could be handled independently to some extent. So, some embodiments are configured to run parallel tasks for each database, and for each collection, and even further for each partition.

Other embodiments eliminate use of rayon by using a multi-threaded async task executor provided by tokio. Such alternatives kick off async tasks for each database, and, within those tasks, for each collection, and, within those tasks, for each partition. This implementation avoids awaiting any tasks until absolutely necessary, ensuring that as many tasks as possible will be executed in parallel by the tokio runtime.

The following example provides an outline of what this an implementation of the build_schema/sample function:

```
Unset
...
  // To start computing the schema for all databases, we need to wait for
  // list_dbs to finish.
  let databases = client.list_database_names(None, None).await.unwrap( );
  // iterate through each database and spawn a new async task
  // to compute db schema. not awaiting the
  // spawned tasks. Async task will start running in the background
  // , but the program will continue executing the iteration
  // since tokio::spawn returns a JoinHandle.
  let db_tasks = databases.unwrap( ).into_iter( ).map(|db_name| {
  // To avoid passing a reference to the client around, create
  // a Database object before spawning the db-schema task. E.g., let db = cli
  ent.database(db_name.as_str( ));
  tokio_handle::spawn(async move {
  // To start computing the schema for all collections in a
  // database, we need to wait for list_collections to finish. let collections =
  list_collections(&db).await;
  // iterate through each collection and spawn a new
  // async task to compute each collection schema
  // not awaiting the spawned tasks. Async
  // task will start running in the background immediately, but
  // the program will continue executing the iteration through all
  // collections since tokio::spawn immediately returns a
  // JoinHandle.
  let coll_tasks = collections.into_iter( ).map(|coll| {
  let db = db.clone( );
  let coll = db.collection::<Document>(coll.as_str( ));
  });
  // Omitted for brevity. The “compute_schema” function
  // represents most of the code for
  // partitioning and deriving schema. Updated
  // in various examples to remove rayon and only use tokio.
  // The compute_schema function sends the schema over
  // argued channel when it is ready. tokio_handle::spawn(compute_schema(db, coll,
  tx_schemata))
  // After spawning async tasks for each collection, the
  // step for computing this db's schema waits for
  // collection-schema tasks to finish. Join_all collection
  // task JoinHandles and await the result. Iterate through
  // results, reporting any errors. future::join_all(coll_tasks)
  .await
  .into_iter( )
  .for_each(|coll_schema_res| match coll_schema_res {
  Err(_) => /* error handling omitted */
  Ok(( )) => { } // Nothing to do here
  });
  })
  });
  // Return the db name for notification purposes
tx_notifications.send(Finished(db.name( )));
  ( )
  // After spawning async tasks for each db, computing
  // the full schema waits for db-schema tasks to finish.
  // join_all db task JoinHandles and await the result. Then iterate
  // through each result and report any errors. future::join_all(db_tasks)
    .await
    .into_iter( )
    .for_each(|db_schema_res| match db_schema_res { Err(_) => /* error handling
    omitted */, Ok(( )) => { } // Nothing to do here
  });
```

According to various embodiments, the above pseudo-code implementation omits namespace filtering and view handling. Other examples include these functions via use of the filter, filter_map, and/or partition iterator methods. These features of the implementation are left out of this design doc above to provide focus and clarity on the basic functionality of the refactor.

### Example Updates: General Refactors

According to various embodiments, a handful of updates are integrated into the library (and, consequently, to the other consumer of this library, bic-trip):
Type refactor
   The internal helper function gen partitions will return a Vec<Partition>rather than a Map<String, Vec<Partition>>. This is because it currently only ever returns a single-element map where the key is the collection name that the caller already knows.
      According to one example, this function calculates the virtual partitions used for parallel querying. The system can take advantage of a special internal index MongoDB builds by using $sampleRate to get a/roughly/(not exact) uniform distribution of partition boundaries. Other approach can be used to build rough partitions in not MongoDB settings including sampling approaches or native functions.
   This leads to natural refactors down the line that will not be detailed here, as various considerations are illustrated herein such as in derive schema for partitionsand bic-trip;: handle schema
Reorder the pipeline in get boundso that the $limit (known MongoDB operator) comes before the $project (known MongoDB operator).
Various embodiments consider removing the final partition
tx_errors can be removed in various examples as extraneous. Errors can be communicated across the other channels. For example, the caller can provide a fully constructed mongodb::Client, there should be no initial errors.
Ensuring only relevant functions are public.
   This embodiment uses only build_schema.

Most functions in the library several functions can be directly unit tested—these example properties illustrate additional features to facilitate understanding.
schema_for_bson
   Testing can be omitted for this one since it is essentially a 1-to-1 mapping between Bsontypes and Schema::Atomictypes.
schema_for_document
   Empty bson::Document produces a schema::Document with no keys or required and additional_properties false.
   Single-element bson::Document produces a schema::Document with the single key, requiring that key, and additional_propertiesfalse.
   Multi-element bson::Documentproduces a schema::Documentwith all of the keys, marking all as required, and additional_properitesfalse.
schema_for_bson_array
   Empty [bson::Bson] produces a schema::Arrayof schema::Any.
   Single-element [bson::Bson] produces a schema::Array of that single element's schema.
   Multi-element [bson::Bson] where every element has the same schema produces a schema::Arraywith that single schema.
   Multi-element [bson::Bson] where each element has a different schema produces a schema::Arraywith the union of all element schemas.
generate_partition_match_with_doc
   With Noneproduces match doc without a schema predicate.
   With Someproduces a match doc with a schema predicate.
get_num_partitions
   Less than 100 MB produces 1 partition.
   More than 100 MB produces multiple partitions.

### Integration Testing of Implementation

Example considerations and properties for integration testing illustrate additional features to facilitate understanding. Two types of integration testing for the library are discussed: function-level and api-level. Both types of testing will require a running database to work. Requires data loaded into that database, so create a small data-loader executable to produce arbitrary data. The data-loader will produce at least 2 databases, each with at least one collection <100 MB in size with uniform data, one collection <100 MB in size with nonuniform data, one collection >100 MB in size with uniform data, and one >100 MB in size with nonuniform data, and one view. The data will be generated in a deterministic way so the tests can expect specific result sets. The data-loader should also manually create the expected
sql_schemascollections in each database.

The function-level integration testing is akin to unit testing but with database access. These tests will require a running database to work. The functions they will target are:
get_size_counts
   One test per collection per database from the data-loader.
      Each test should expect the known size and count.
get_bounds
   One test per collection per database from the data-loader.
      Each test should expect the known minimum bound (and the maximum bound of MaxKey)
get_partitions
   For the <100 MB collections, the tests should expect a single partition.
   For the >100 MB collections, the tests should expect the appropriate number of partitions with correct values.
derive_schema_for_partition
   For the <100 MB collections, the tests should expect the full schema since those collections are represented as a single partition.
   For the >100 MB collections, the tests should expect the appropriate schema for a given partition.

The api-level integration testing will cover the public build_schema function itself. These tests should cover the different BuilderOptions configurations.
A test with neither include nor exclude lists specified, covering all namespaces
A test with an include list that covers only a subset of namespaces that are explicitly named (e.g. include: [db1.small_uniform, db2.large_mixed])
A test with an includelist that covers only one database, using wildcard syntax (e.g. include: [db1.*])
A test with an exclude list that covers only a subset of namespaces that are explicitly named
A test with an exclude list that covers only one database, using the wildcard syntax
A test with both an include and an exclude list (e.g. include: [db1.*], exclude: [db1.mixed_uniform])
A test that uses initial schema information
   This test will not be noticeably different from the other tests that do not use this parameter, beyond ensuring it does not panic.

Further embodiments can include options to permit a collection called_sql_schemasin their databases, because Option<String>contains the name of the schemas collection to look for, the system can enable the CLI behavior to accept a user-specified schema collection. Other embodiments can leverage crate functions (e.g., rayon and tokio) differently. For example, rayon offers two main ways of using the crate: high-level parallel constructs, and custom tasks. Various embodiments described herein uses custom tasks. The high-level parallel constructs (particularly parallel iterators) can also be used to avoid coordination with as much custom code.

This approach is similar to the tokio-only example discussed-parallel handling of each database, then each collection, and then each partition. Since async code cannot be run directly inside a rayon thread, examples use tokioto obfuscate the asynchronous code. An outline in pseudo-code for the build_schema/sample function follows:

```
    Unset
    // To start computing the schema for all databases, we need to wait for
    // list_dbs to finish.
    let databases = client.list_database_names(None, None).await;
    // use a rayon parallel iterator to iterator through
    // database in parallel. Each database is handled by spawning a
    // tokio task that asynchronously builds the schema for that db.
    // not awaiting the spawned tasks. Each async
    // task will start running in the background immediately, but the
    // program will continue executing the iteration since tokio::spawn
    // immediately returns a JoinHandle. let database_tasks: Vec<_ > = databases
    .unwrap( )
        .into_par_iter( )
        .map(|db_name| {
        let db = client.database(db_name.as_str( ));
          db.
    {
    // Similar to Idea 1, we start an async task for handling each
    tokio::spawn(async move {
    let collections = list_collections(&db).await;
    let coll_tasks = collections.into_par_iter( ).map(|coll_name|
    let coll = db.collection::<Document>(coll_name.as_str( )); tokio::spawn(async move {
    let partitions = get_partitions(coll).await; let partition_tasks = partitions
    .into_par_iter( )
    .map(|partition| tokio::spawn( derive_schema_for_partition(partition)
    ))
    .collect::<Vec<JoinHandle<Schema>>>( );
    let coll_schema = future::join_all(partition_tasks)
    .await
    .into_iter( )
    .map(|part_schema| match part_schema {
    Err(e) => panic!( ), /* error handling omitted
    */
    Ok(part_schema) => part_schema,
    })
    .reduce(|acc, part_schema| { acc.union(&part_schema)
  })
                .unwrap( );
              tx_schemata.send(coll_schema);
              ( )
            })
          });
      future::join_all(coll_tasks)
      .await
      .into_iter( )
      .for_each(|coll_schema_res| match coll_schema_res { Err(_) => { } /* error handling
      omitted */ Ok(( )) => { } // Nothing to do here
      });
    })
  })
  .collect( );
  future::join_all(database_tasks).await.into_iter( ).for_each(|db_schema_r es| match
db_schema_res {
  Err(_) => { } /* error handling omitted */
  Ok(( )) => { } //
  });
```

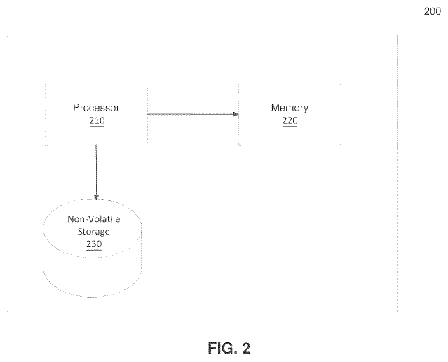

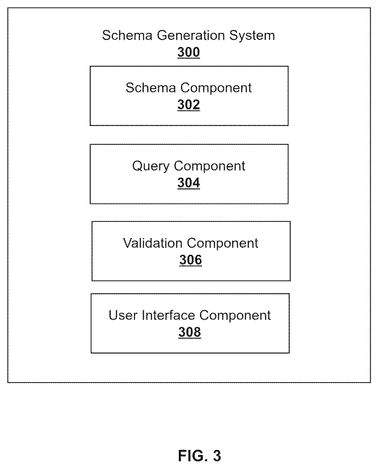

Referring to FIG. 3, a Schema Generation System 300 is illustrated that is configured for generating and validating schemas in a dynamic schema database. The Schema Generation System 300 may include a Schema Component 302, a Query Component 304, a Validation Component 306, and a User Interface Component 308. The Schema Generation System 300 may be implemented using the processor 210 and the memory 220 of the computer system 200 described with reference to FIG. 2.

The Schema Component 302 may be configured to manage schema construction and maintain schema definitions, including initial schemas and updated schemas generated through iterative processing. In some embodiments, the Schema Component 302 may identify any initial schema, where the initial schema may be pre-defined, sampled, or user submitted. The Schema Component 302 may compute jsonSchema representation for documents by examining document fields and values to create type definitions including object, string, boolean, and number types. For example, when processing a document having fields with string, boolean, and number values, the Schema Component 302 may generate a corresponding jsonSchema representation that specifies the type for each field property.

With continued reference to FIG. 3, the Query Component 304 may be configured to execute query operations to identify source data that does not match a current schema definition, enabling the Schema Generation System 300 to discover attributes that may be added to the schema. In various embodiments, the Query Component 304 may trigger a query operation to identify source data (e.g., documents) not matching the initial schema. The Query Component 304 may use a $jsonSchema query operator to find documents that do not match an existing computed schema or defined schema. Each iteration of the query operation may analyze fewer documents as new properties are added to the schema through the iterative schema building process.

The Validation Component 306 may be configured to validate schemas, including performing similarity analysis to evaluate a target grouping of source data comprising dynamic schema data against a schema for the target. In some cases, the Validation Component 306 may implement a Jaccard index that defines the intersection of the keys in two documents divided by the union of two keys to measure set similarity. The Jaccard index may be used to gauge the similarity and diversity of sample sets by taking the ratio of the intersection size divided by the union size. In further embodiments, the Validation Component 306 may consider documents that are a strict subset or superset of each other as identical, allowing schema growth that would be expected to happen naturally over time without impacting the index. For example, if a first document has keys {a, b} and a second document has keys {a, b, c}, the first document may be considered a subset of the second document, and the second document may be considered a superset of the first document.

The User Interface Component 308 may be configured to accept instructions to build schemas, evaluate arguments and options included with the instructions, and provide access to schema builder functionality. The User Interface Component 308 may function similarly to the interface 106 described with reference to FIG. 1, enabling administrator users or database users to access and manage schema building operations. In some examples, the User Interface Component 308 may be configured to define, accept, and execute command line instructions for schema builder functions, including arguments and options that control and alter execution of the schema building operations.

The components of the Schema Generation System 300 may work together to implement an iterative query approach that identifies source data not within an existing schema definition, captures attributes from non-matching data, and integrates those properties into the schema definition until no non-matching results are returned or until a threshold is reached.

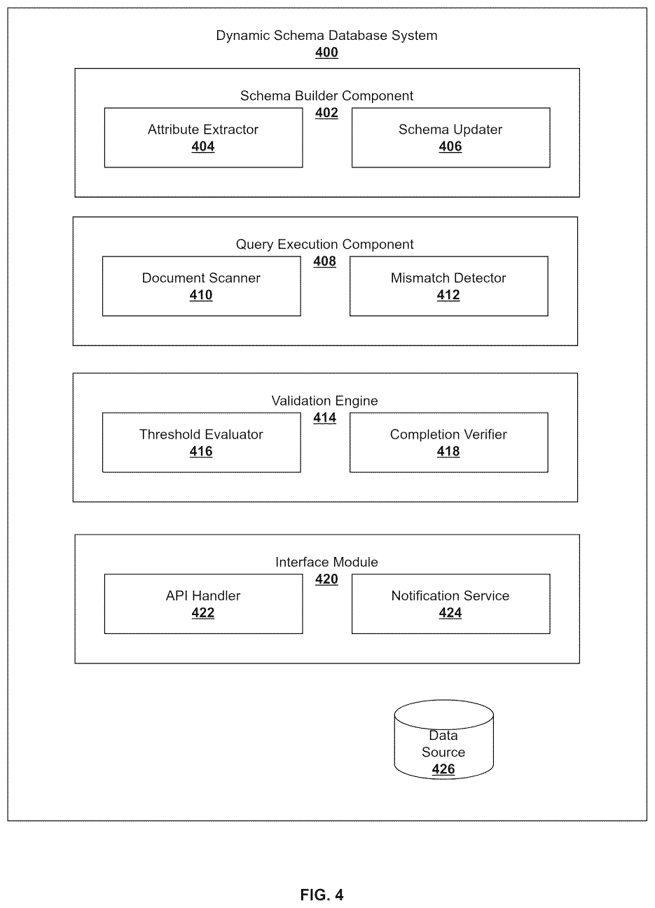

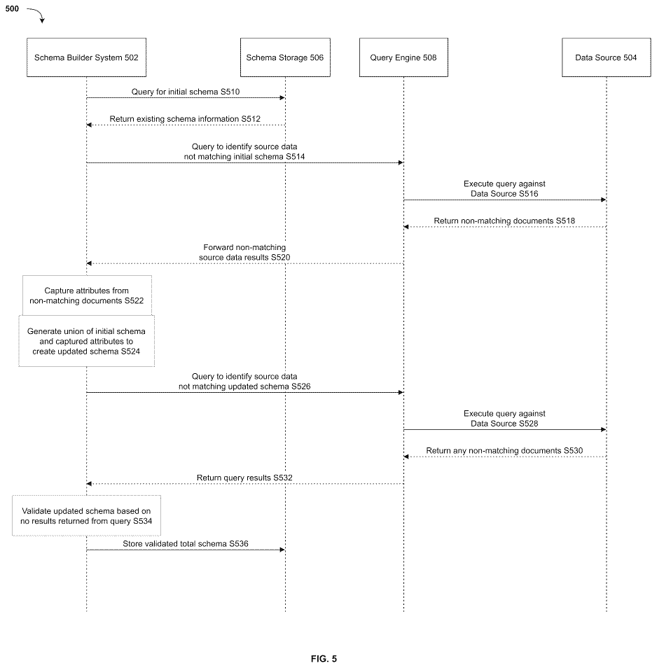

Referring to FIG. 4, a Dynamic Schema Database System 400 is illustrated that is configured to generate and manage schema representations for dynamic schema databases. The Dynamic Schema Database System 400 includes a Schema Builder Component 402, a Query Execution Component 408, a Validation Engine 414, an Interface Module 420, and a Data Source 426. The Dynamic Schema Database System 400 may implement the iterative query approach described herein to identify source data not within an existing schema definition and integrate properties from that data into a schema definition.

The Schema Builder Component 402 is configured to construct and update schema definitions for dynamic schema data. The Schema Builder Component 402 includes an Attribute Extractor 404 and a Schema Updater 406. The Attribute Extractor 404 is configured to capture attributes from documents not matching an initial schema. In some cases, the Attribute Extractor 404 may examine each non-matching document to determine field names, field types, and structural properties that are not represented in a current schema definition. The Attribute Extractor 404 may extract these attributes for use in updating the schema definition.

The Schema Updater 406 is configured to generate a union of an initial schema and the attributes to generate an updated schema. The Schema Updater 406 may implement schema unioning as additive for properties and reductive for required data in the event of new or different elements being captured. For example, when two documents have differing schemas, the Schema Updater 406 may add new properties from both documents to the updated schema while reducing the required fields to include only those fields that appear in every document encountered. In some cases, the Schema Updater 406 may implement schema simplification that removes nested AnyOf structures, removes duplicates, and handles Missing types in documents.

With continued reference to FIG. 4, the Schema Builder Component 402 may implement a Schema enum with variants including Unsat, Missing, Atomic, Array, Document, AnyOf, and Any for representing all possible schema types. The Unsat variant may represent an unsatisfiable schema, the Missing variant may represent a missing field, the Atomic variant may represent atomic types such as String, Integer, Boolean, and other primitive types, the Array variant may represent array types, the Document variant may represent document or object types, the AnyOf variant may represent a union of multiple possible types, and the Any variant may represent any type. The Schema Builder Component 402 may also implement a Document struct with a keys BTreeMap for storing field names and their associated schemas, a required BTreeSet for tracking which fields are required, an additional_properties boolean for indicating whether additional properties are permitted, and optional jaccard_index fields for tracking schema stability.

The Schema Builder Component 402 may implement schema intersection operation that returns a maximal schema R such that R satisfies both input schemas. In some cases, the schema intersection operation may be used to determine common schema elements between two schema definitions. The Schema Builder Component 402 may use the schema intersection operation in conjunction with the schema union operation performed by the Schema Updater 406 to manage schema evolution during the iterative schema building process.

The Query Execution Component 408 is configured to execute query operations against the Data Source 426 to identify source data not matching current schema definitions. The Query Execution Component 408 includes a Document Scanner 410 and a Mismatch Detector 412. The Document Scanner 410 is configured to scan documents within collections or other logical groupings of source data stored in the Data Source 426. In some cases, the Document Scanner 410 may traverse partitions of a collection to examine documents for schema conformance. The Mismatch Detector 412 is configured to identify documents having properties that are not represented in a current schema definition by detecting documents that do not conform to the current schema definition. The Document Scanner 410 and the Mismatch Detector 412 work together to identify documents not conforming to current schema definitions. For example, the Document Scanner 410 may retrieve documents from the Data Source 426, and the Mismatch Detector 412 may evaluate each retrieved document against the current schema definition to determine whether the document matches the schema. In some cases, the Mismatch Detector 412 may use a $jsonSchema query operator to find documents that do not match an existing or computed schema.

As further shown in FIG. 4, the Validation Engine 414 is configured to validate schema completeness and manage termination conditions for schema building operations. The Validation Engine 414 includes a Threshold Evaluator 416 and a Completion Verifier 418. The Threshold Evaluator 416 is configured to evaluate threshold conditions for schema creation, such as a number of documents processed, a number of queries executed, or similarity threshold values. In some cases, the Threshold Evaluator 416 may use a Jaccard index or other set similarity measure to determine whether schema changes are occurring too rapidly, which may indicate schema instability.

The Completion Verifier 418 is configured to verify that an updated schema is complete based on no results being returned from query operations to identify non-matching documents. When the Mismatch Detector 412 returns no non-matching documents, the Completion Verifier 418 may determine that the schema building process has completed and that the current schema represents a total schema for the target collection or view.

The Interface Module 420 is configured to enable users to access and manage schema builder functionality. The Interface Module 420 includes an API Handler 422 and a Notification Service 424. The API Handler 422 is configured to accept instructions to build schemas, evaluate arguments and options included with the instructions, and execute the instructions against groupings of source data. In some cases, the API Handler 422 may accept command line instructions or programmatic API calls to initiate schema building operations.

The Notification Service 424 is configured to send activity messages and notifications to callers regarding schema building operations. The Notification Service 424 may send querying notifications when the Query Execution Component 408 issues queries, processing notifications when the Schema Builder Component 402 performs schema merging operations, partitioning notifications when calculating partitions for a collection, and error notifications when errors occur during builder operations.

The Data Source 426 represents dynamic schema data storage, such as document-based data organized in collections or other logical groupings. The Data Source 426 stores source data units that are analyzed during schema building operations to construct total schemas for the dynamic schema database. In some cases, the Data Source 426 may be implemented as a MongoDB database or other dynamic schema database system.

Referring to FIG. 5, a sequence diagram representing a total schema generation process 500 for a dynamic schema database is illustrated. The diagram includes a Schema Builder System 502, a Data Source 504 (e.g., dynamic schema database), a Schema Storage 506, and a Query Engine 508. The total schema generation process 500 demonstrates a computer implemented method for generating a schema representation in a dynamic schema database.

The process 500 begins with the Schema Builder System 502 querying the Schema Storage 506 in step S510 to identify any initial schema (e.g., pre-defined, sampled, or user submitted) for existing collections of data. In some embodiments, the Schema Builder System 502 implements a query_for_initial_schemas function that retrieves existing schema documents from a schema collection for seeding. The Schema Storage 506 returns any existing schema information to the Schema Builder System 502 in step S512, including partial or sampled schema data if available. In various implementations, the Schema Builder System 502 stores schema information in a sql_schemas collection in each database in jsonSchema format.

With continued reference to FIG. 5, the Schema Builder System 502 then triggers a query operation by sending a query to the Query Engine 508 in step S514 to identify source data (e.g., documents) not matching the initial schema. In some embodiments, the Schema Builder System 502 implements a generate_partition_match function that creates a $match stage with a $nor clause containing a jsonSchema predicate for finding non-matching documents. The Query Engine 508 executes the query against the Data Source 504 in step S516 to find documents that do not match the initial schema definition. The Data Source 504 returns non-matching documents to the Query Engine 508 in step S518, which are then forwarded to the Schema Builder System 502 in step S520.

In step S522, the Schema Builder System 502 captures attributes from the documents not matching the initial schema. The Schema Builder System 502 then generates a union of the initial schema and the captured attributes to create an updated schema in step S524. In some embodiments, the Schema Builder System 502 implements a derive_schema_for_partition function that iteratively queries for non-matching documents and unions their schemas.

As further shown in FIG. 5, the iterative process continues as the Schema Builder System 502 re-executes the query operation by sending another query to the Query Engine 508 in step S526 to identify source data (e.g., documents) not matching the updated version of a schema. The Query Engine 508 executes this query against the Data Source 504 in step S528, and the Data Source 504 returns any non-matching documents in step S530. The Query Engine 508 returns the query results to the Schema Builder System 502 in step S532.

In step S534, the Schema Builder System 502 validates the updated schema based on no results returned on a query operation to identify documents not matching the updated schema. When the query operation returns no non-matching documents, the Schema Builder System 502 determines that the schema is complete and validated. Finally, in step S536, the Schema Builder System 502 stores the validated total schema in the Schema Storage 506.

The total schema generation process 500 may be implemented as a system for generating a schema representation in a dynamic schema database, where at least one processor operatively connected to a memory executes the steps described above. The process 500 may also be implemented as a computer implemented method for generating a schema representation in a dynamic schema database, where the at least one processor identifies any initial schema, triggers query operations to identify non-matching source data, captures attributes from non-matching documents, generates union schemas, re-executes query operations iteratively, and validates the updated schema based on no results returned on a recent query operation to identify documents not matching the updated schema.

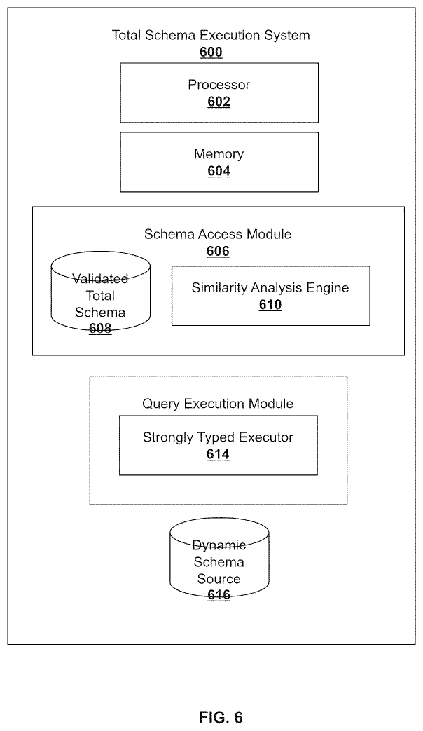

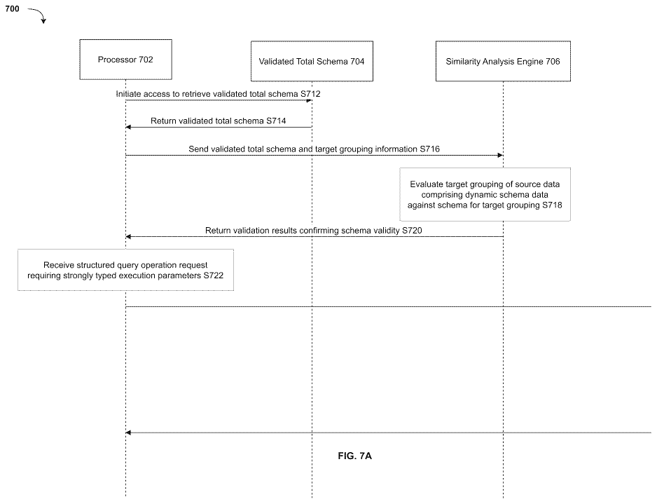

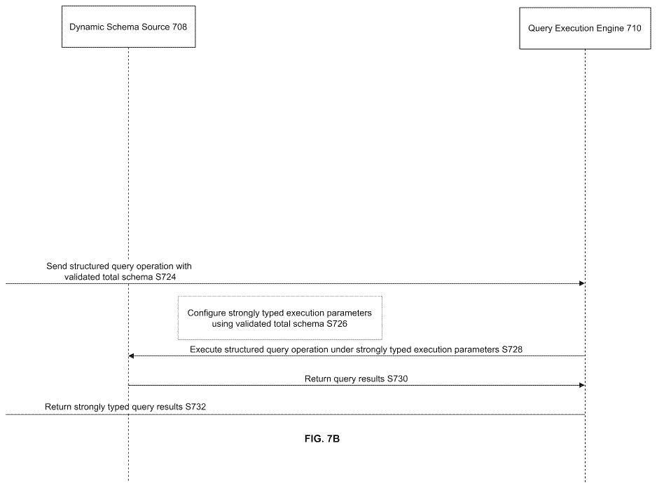

Referring to FIG. 6, a Total Schema Execution System 600 is illustrated that is configured for using a total schema defined on a dynamic schema database. The Total Schema Execution System 600 may include a Processor 602, a Memory 604, a Schema Access Module 606, a Query Execution Module 612, and a Dynamic Schema Source 616. The Processor 602 may be operatively connected to the Memory 604 and may be configured to execute operations for accessing validated schemas and executing structured query operations on dynamic schema sources. The Memory 604 may store processor-executable instructions and data structures used during schema execution operations.

With continued reference to FIG. 6, the Schema Access Module 606 may be configured to manage access to schema information and perform validation operations. The Schema Access Module 606 may include a Validated Total Schema 608 and a Similarity Analysis Engine 610. The Validated Total Schema 608 may store schema definitions that have been validated through the schema building process described herein. The Similarity Analysis Engine 610 may be configured to perform similarity analysis evaluating a target grouping of source data comprising dynamic schema data against a schema for the target grouping, enabling validation of schema completeness and accuracy.

In some embodiments, the Similarity Analysis Engine 610 may implement a stability_limit threshold of 0.8 for a Jaccard index to determine when schema instability triggers conversion to an Any document type. The Similarity Analysis Engine 610 may calculate a stabilization_rate as 1.0 divided by the number of unions to provide an easing effect that becomes less tolerant of change over time. This approach allows the system to detect when documents are wildly different and would cause excessive query operations.

As further shown in FIG. 6, the Query Execution Module 612 may be configured to execute structured query operations on dynamic schema sources. The Query Execution Module 612 may include a Strongly Typed Executor 614. The Strongly Typed Executor 614 may be configured to execute structured query operations under strongly typed execution parameters, wherein the execution includes use of the Validated Total Schema 608 to enable strongly typed execution of the structured query operation. The Dynamic Schema Source 616 may represent the dynamic schema data storage containing source data that is accessed during query execution.

According to various embodiments, the system may implement a Satisfaction enum with Must, May, and Not values for determining schema satisfaction relationships. The Must value may indicate that a schema relationship is satisfied in all cases. The May value may indicate that a schema relationship is satisfied in some cases. The Not value may indicate that a schema relationship is not satisfied. These satisfaction values may be used during query execution to determine how schema constraints apply to source data.

In further embodiments, the system may implement an is_comparable_with function that determines if two schemas are comparable for comparison operations. The is_comparable_with function may include special handling for numeric types, where different numeric types (e.g., Integer, Long, Double, Decimal) may be considered comparable with each other. The is_comparable_with function may also include special handling for null values, where null may be comparable with other atomic types. Arrays and documents may not be comparable with each other or with atomic types in some implementations.

The components of the Total Schema Execution System 600 may work together to enable execution of structured query operations on dynamic schema databases by leveraging validated total schemas that have been constructed through iterative query and schema update operations. The Processor 602 may access the Validated Total Schema 608 through the Schema Access Module 606, where the validation may include the similarity analysis performed by the Similarity Analysis Engine 610. The Processor 602 may then execute a structured query operation on the Dynamic Schema Source 616 under strongly typed execution parameters through the Query Execution Module 612, wherein the execution includes use of the Validated Total Schema 608 to enable the strongly typed execution of the structured query operation.

Referring to FIG. 7, a sequence diagram representing a process 700 for using a total schema defined on a dynamic schema database is illustrated. The process 700 includes several elements: a Processor 702, a Validated Total Schema 704, a Similarity Analysis Engine 706, a Dynamic Schema Source 708, and a Query Execution Engine 710. The process 700 demonstrates a computer implemented method for using a total schema defined on a dynamic schema database, wherein the method includes accessing, by at least one processor, a validated total schema, and executing, by the at least one processor, a structured query operation on a dynamic schema source under strongly typed execution parameters.

The process 700 begins with the Processor 702 initiating access to the Validated Total Schema 704 to retrieve a validated total schema for a target grouping of source data in step S712. The Validated Total Schema 704 returns the validated total schema to the Processor 702 in step S714. The validation of the total schema may include a similarity analysis evaluating a target grouping of source data comprising dynamic schema data against a schema for the target grouping. With continued reference to FIG. 7, the Processor 702 sends the validated total schema and target grouping information to the Similarity Analysis Engine 706 for validation confirmation in step S716. In step S718, the Similarity Analysis Engine 706 evaluates the target grouping of source data comprising dynamic schema data against the schema for the target grouping. The Similarity Analysis Engine 706 may implement various functions to perform the similarity analysis. For example, the Similarity Analysis Engine 706 may implement a get_jaccard_index function that averages Jaccard indices from two documents being unioned. The Similarity Analysis Engine 706 may also implement an update_jaccard_index function that calculates a new average Jaccard index based on union size and intersection size. In some cases, the Similarity Analysis Engine 706 ignores the Jaccard index entirely for the first 5 iterations to provide tolerance for initial schema changes.

The Similarity Analysis Engine 706 may further implement a schema_predicate_meet function that applies predicates to AnyOf schemas and takes the meet of the Satisfaction lattice. Additionally, the Similarity Analysis Engine 706 may implement a satisfies_any_of function that determines if a schema satisfies any member of an AnyOf set. These functions enable the Similarity Analysis Engine 706 to evaluate schema conformance and determine validation status for the total schema.

The Similarity Analysis Engine 706 returns validation results confirming the schema validity to the Processor 702 in step S720. In step S722, the Processor 702 receives a structured query operation request requiring strongly typed execution parameters. The Processor 702 sends the structured query operation to the Query Execution Engine 710 along with the validated total schema in step S724.

As further shown in FIG. 7, in step S726, the Query Execution Engine 710 configures strongly typed execution parameters using the validated total schema. The execution of the structured query operation includes use of the validated total schema to enable the strongly typed execution of the structured query operation. The Query Execution Engine 710 executes the structured query operation against the Dynamic Schema Source 708 under strongly typed execution parameters in step S728. The Dynamic Schema Source 708 returns query results to the Query Execution Engine 710 in step S730. The Query Execution Engine 710 returns the strongly typed query results to the Processor 702 in step S732.

The process 700 enables execution of structured query operations on dynamic schema databases by leveraging validated total schemas that have been constructed through iterative query and schema update operations. The validation of the total schema through similarity analysis prior to query execution ensures that strongly typed execution parameters can be reliably applied to dynamic schema data sources. The Processor 702, the Validated Total Schema 704, the Similarity Analysis Engine 706, the Dynamic Schema Source 708, and the Query Execution Engine 710 work together to implement the computer implemented method for using a total schema defined on a dynamic schema database.

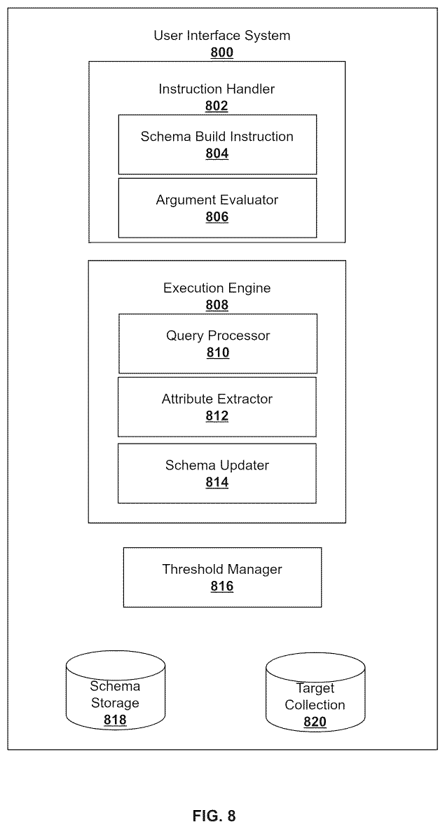

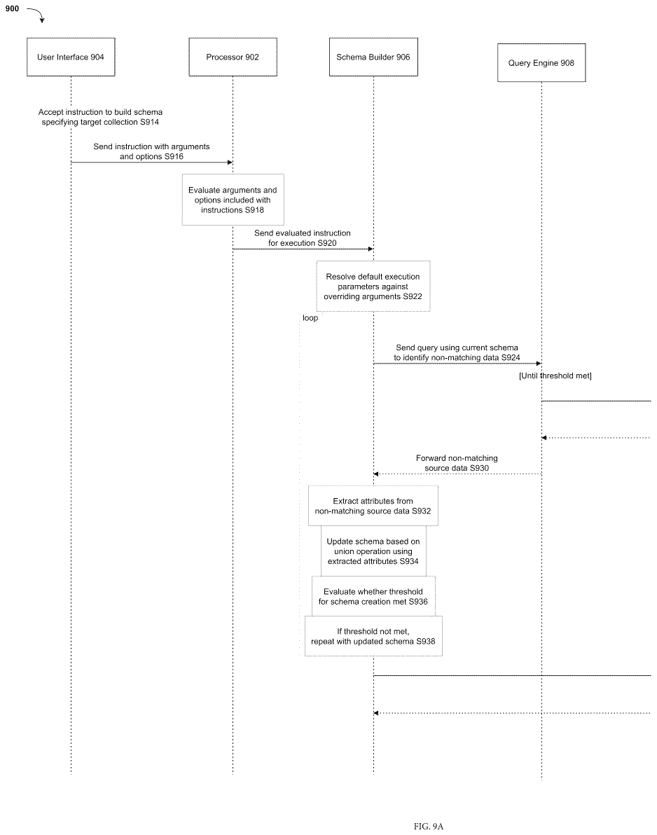

Referring to FIG. 8, a User Interface System 800 is illustrated that is configured for managing construction and definition of a total schema in a dynamic schema database. The User Interface System 800 may be instantiated by at least one processor and may provide functionality for accepting instructions, evaluating parameters, and executing schema building operations against target data groupings. In some cases, the User Interface System 800 may be integrated with or operate in conjunction with the interface 106 described with reference to FIG. 1. The User Interface System 800 may include an Instruction Handler 802 configured to receive and process instructions for schema building operations. The Instruction Handler 802 may include a Schema Build Instruction 804 and an Argument Evaluator 806. The Schema Build Instruction 804 may be configured to accept an instruction to build a schema specifying at least a target comprising a grouping of source dynamic schema data (e.g., collection). In some examples, the Schema Build Instruction 804 may receive instructions via a command line interface or through other interface mechanisms. The Argument Evaluator 806 may be configured to evaluate any arguments and/or options included with the instructions to build the schema. The Argument Evaluator 806 may parse command line arguments and configuration file parameters to determine how schema building operations should be executed.

With continued reference to FIG. 8, the User Interface System 800 may include an Execution Engine 808 configured to execute schema building instructions against groupings of source data. The Execution Engine 808 may include a Query Processor 810, an Attribute Extractor 812, and a Schema Updater 814. The Query Processor 810 may be configured to query using a current schema against a target and identify non-matching source data. The Query Processor 810 may communicate with a Target Collection 820, which represents the grouping of source dynamic schema data being analyzed. The Attribute Extractor 812 may be configured to extract attributes from the non-matching source data identified by the Query Processor 810. The Schema Updater 814 may be configured to update the current schema using the extracted attributes and an initial schema, for example through a union operation.

The User Interface System 800 may further include a Threshold Manager 816 configured to manage threshold conditions for schema creation. The Threshold Manager 816 may evaluate conditions such as the number of documents processed, number of queries executed, or similarity threshold values to determine when the iterative schema building process should terminate. The User Interface System 800 may also include a Schema Storage 818 configured to store a final schema associated with the target that satisfies the threshold for schema creation. The Schema Storage 818 may receive validated schemas from the Threshold Manager 816 for persistent storage.

In various embodiments, the execution of instructions by the User Interface System 800 may be tailored based on any argument or option, including operations to resolve default execution against overriding arguments or options. For example, the Argument Evaluator 806 may implement a merge function that combines two configuration structures, preferring left values over right values for optional fields. In some cases, the User Interface System 800 may implement a Cli struct with clap Parser derive for command line argument parsing with serde Serialize/Deserialize for configuration file support.

As further shown in FIG. 8, the User Interface System 800 may implement a dry_run option that outputs a list of collections/views it would have built a schema for without performing further analysis. The dry_run option may be evaluated by the Argument Evaluator 806 and may cause the Execution Engine 808 to enumerate target collections without executing schema building operations. In some embodiments, the User Interface System 800 may implement a SchemaAction enum with Overwrite and Merge variants for specifying behavior when a schema already exists. The Overwrite variant may cause the Schema Updater 814 to ignore existing schema information, while the Merge variant may cause the Schema Updater 814 to combine existing schema with new schema information.

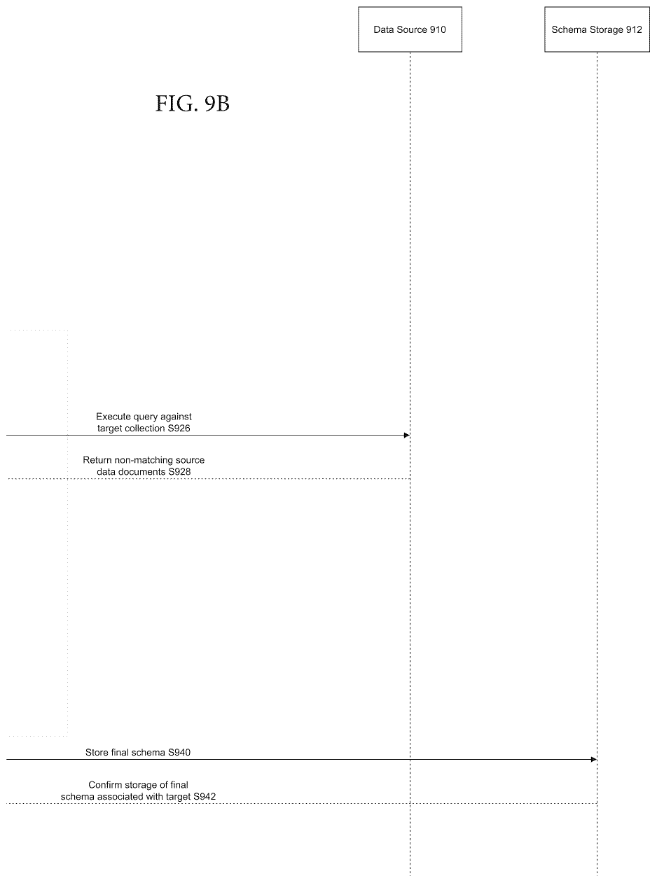

Referring to FIG. 9, a schema construction process 900 for managing construction and definition of a total schema in a dynamic schema database is illustrated. The process 900 includes a Processor 902, a User Interface 904, a Schema Builder 906, a Query Engine 908, a Data Source 910, and a Schema Storage 912. The Processor 902 may be operatively connected to a memory and configured to execute operations for schema construction and management. The User Interface 904 may be configured to accept instructions and provide access to schema building functionality. The Schema Builder 906 may be configured to construct and update schema definitions through iterative processing. The Query Engine 908 may be configured to execute query operations against the Data Source 910. The Data Source 910 may store dynamic schema data such as document-based data organized in collections or other logical groupings. The Schema Storage 912 may be configured to store schema definitions generated through the schema construction process 900.

In step S914, the User Interface 904 accepts an instruction to build a schema specifying at least a target comprising a grouping of source dynamic schema data (e.g., a collection). The instruction may include various arguments and options that control execution of the schema building operation. In step S916, the User Interface 904 sends the instruction with arguments and options to the Processor 902 for evaluation. In step S918, the Processor 902 evaluates any arguments and/or options included with the instructions to build the schema. The evaluation may include parsing command line arguments, validating option values, and determining execution parameters based on the provided arguments.

With continued reference to FIG. 9, in step S920, the Processor 902 sends the evaluated instruction to the Schema Builder 906 for execution against the target collection. In step S922, the Schema Builder 906 resolves default execution parameters against any overriding arguments or options received. The execution may be tailored based on any argument or option, including operations to resolve default execution against overriding arguments or options. For example, the Schema Builder 906 may implement a PARTITION_DOCS_PER_ITERATION constant of 20 documents to limit the result set during each query iteration. In some cases, the Schema Builder 906 may implement a VIEW_SAMPLE_SIZE constant of 1000 for sampling views during schema derivation.

In step S924, the Schema Builder 906 sends a query using a current schema to the Query Engine 908 to identify non-matching source data. The query may be configured to find documents that do not match the current schema definition. In some cases, the Schema Builder 906 may maintain an ignored_ids list to exclude certain documents that have been processed and match the current schema. In step S926, the Query Engine 908 executes the query against the Data Source 910 targeting the specified collection. The Query Engine 908 may use AggregateOptions with a hint set to an_id index for optimized query execution during partition schema derivation.

As further shown in FIG. 9, in step S928, the Data Source 910 returns non-matching source data documents to the Query Engine 908. In step S930, the Query Engine 908 forwards the non-matching documents to the Schema Builder 906. In step S932, the Schema Builder 906 extracts attributes from the non-matching source data. The attribute extraction may include determining field names, field types, and structural properties of the non-matching documents.

In step S934, the Schema Builder 906 updates the initial schema based on a union operation using the extracted attributes and the initial schema. The union operation may be additive for properties and reductive for required data in the event of new or different elements being captured. In step S936, the Schema Builder 906 evaluates whether a threshold for schema creation has been met. The threshold may be based on a number of documents processed, a number of queries executed, a similarity threshold, or other criteria. In step S938, if the threshold is not met, the Schema Builder 906 repeats steps S924-S936 with the updated schema. The iterative process continues until the threshold for schema creation is satisfied.

With continued reference to FIG. 9, upon threshold satisfaction, in step S940, the Schema Builder 906 stores the final schema in the Schema Storage 912. The final schema may be associated with the target collection and may satisfy the threshold for schema creation. In step S942, the Schema Storage 912 confirms storage of the final schema associated with the target to the Schema Builder 906.

According to various embodiments, a system for managing construction and definition of a total schema in a dynamic schema database may include at least one processor operatively connected to a memory. The at least one processor, when executing, may be configured to accept an instruction to build a schema specifying at least a target comprising a grouping of source dynamic schema data. The at least one processor may evaluate any arguments and/or options included with the instructions to build the schema. The at least one processor may execute the instruction against the grouping of source data, wherein the execution is tailored based on any argument or option, including operations to resolve default execution against overriding arguments or options. In response to execution of the instruction, the at least one processor may query using a current schema against the target and identify non-matching source data, extract attributes from the non-matching source data, update the initial schema based on a union operation using the attributes and the initial schema, and repeat these operations until a threshold for schema creation is met. The at least one processor may store a final schema associated with the target satisfying the threshold for schema creation.

According to further embodiments, a computer implemented method for managing construction and definition of a total schema in a dynamic schema database may include accepting, by at least one processor, an instruction to build a schema specifying at least a target comprising a grouping of source dynamic schema data. The method may include evaluating, by the at least one processor, any arguments and/or options included with the instructions to build the schema. The method may include executing, by the at least one processor, the instruction against the grouping of source data, wherein the execution is tailored based on any argument or option, including operations to resolve default execution against overriding arguments or options. Executing may include querying using a current schema against the target and identifying non-matching source data, extracting attributes from the non-matching source data, updating the initial schema based on a union operation using the attributes and the initial schema, and repeating these operations until a threshold for schema creation is met. The method may include storing a final schema associated with the target satisfying the threshold for schema creation.

According to some embodiments, a schema builder component may partition data groups to improve processing and efficiency. For example, collections may be partitioned into chunks of approximately 100 megabytes (MB). In various implementations, a partition size constant may be defined as PARTITION_SIZE_IN_BYTES with a value of 100 1024 1024 bytes (100 MB) for determining partition boundaries. The partition size may be based on operational defaults of a respective database management system or settings made on respective database systems.

In some cases, the schema builder component may use a $bucketAuto stage that groups on the_id field to find a minimum bound within each chunk when partitioning collections. For collections that are less than or equal to 100 MB in size, the partition operation may be skipped, and instead the entire collection may be considered as a single partition. In other cases, the schema builder component may use $sampleRate based on a desired number of partitions to obtain a roughly uniform distribution of partition boundaries.

According to various embodiments, a Partition struct may be implemented with min, max, and is_max_bound_inclusive fields for defining collection partition boundaries. The min field may specify a lower bound identifier value for the partition, while the max field may specify an upper bound identifier value. The is_max_bound_inclusive field may indicate whether the maximum bound is inclusive of documents having that identifier value.

In further embodiments, a CollectionSizes struct may be implemented with size and count fields. The CollectionSizes struct may be returned by a get_size_counts function that uses a $collStats aggregation operation to determine the size and document count of a collection. The size field may represent the total size of the collection in bytes, while the count field may represent the total number of documents in the collection.

According to some implementations, a get_bounds function may be implemented that determines minimum and maximum_id values using $sort and $limit aggregation stages. The get_bounds function may issue an aggregation pipeline that sorts documents by the_id field and limits results to retrieve boundary values for partitioning purposes. In some cases, the $limit stage may be ordered before a $project stage in the aggregation pipeline.

In various embodiments, a get_num_partitions function may be implemented that divides a collection size by the partition size and adds 1 to determine a partition count. For example, if a collection has a size of 250 MB and the partition size is 100 MB, the get_num_partitions function may calculate 250/100+1=3 partitions. Collections with sizes less than or equal to 100 MB may result in a single partition being returned by the get_num_partitions function.

According to some embodiments, the schema builder component is configured to identify and leverage existing schema information when constructing a total schema for a dynamic schema database. The existing schema information may include partial schema data, sampled schema data, or other previously defined schema definitions. When the schema builder encounters a collection or view, the schema builder may fetch an initial schema if schema information is available in a designated schema collection. The initial schema information can speed up schema building operations because documents in the collection that conform to the existing schema will not be returned by queries for non-matching documents.

In some cases, when no initial schema exists for a partition, the schema builder may implement a seed schema approach. According to one embodiment, a query component seeds the schema for a partition by issuing an aggregation operation that sorts based on the Lid field and limits the result set to a predetermined number of documents. In one example, the aggregation operation limits the result set to 20 documents. In other examples, different numbers of documents may be used, such as 15, 25, or 30 documents. The schema for these selected documents is computed and used to seed the schema for the partition. The seeded schema then serves as the starting point for subsequent iterative query operations that identify documents not matching the seeded schema.

According to various embodiments, a schema builder component may implement a schema\_for_document function from a schema derivation module that generates a Schema from a bson::Document. The schema\_for_document function examines the fields and values within a document to produce a schema representation. For example, when processing a bson::Document, the schema\_for_document function may generate a schema::Document that includes the keys present in the bson::Document, marks the keys as required, and sets additional\_properties to false. An empty bson::Document may produce a schema::Document with no keys, no required fields, and additional\_properties set to false. A single-element bson::Document may produce a schema::Document with the single key, requiring that key, and additional\ properties set to false. A multi-element bson::Document may produce a schema::Document with all of the keys, marking all keys as required, and additional\_properties set to false.

The schema derivation module may also include functions for processing other document based data types (e.g., BSON types). For example, a schema\_for_bson function may provide a mapping between BSON types and Schema::Atomic types. A schema\_for_bson\_array function may process arrays of BSON values. An empty array may produce a schema::Array of schema::Any. A single-element array may produce a schema::Array of that single element's schema. A multi-element array where every element has the same schema may produce a schema::Array with that single schema. A multi-element array where each element has a different schema may produce a schema::Array with the union of all element schemas.

According to various embodiments, a system for generating a schema representation in a dynamic schema database may be configured to generate a custom set similarity index score and manage execution of schema operations using a threshold value for the custom set similarity index score to prevent runaway querying. In some cases, a computer implemented method for generating a schema representation in a dynamic schema database may include generating a custom set similarity index score and managing execution of schema operations using a threshold value for the custom set similarity index score to prevent runaway querying.

In various implementations, the custom set similarity index score may be computed using a Jaccard index. The Jaccard index is defined as the intersection of keys in two documents divided by the union of keys in the two documents. Stated more generally, the Jaccard index provides a measure for gauging the similarity and diversity of sample sets by taking the ratio of the intersection size divided by the union size. For example, given a first document with keys {a, b, c} and a second document with keys {b, c, d}, the intersection of keys is {b, c} and the union of keys is {a, b, c, d}. The Jaccard index in this example would be 2/4 or 0.5.

According to some embodiments, the system may be configured to ensure the similarity index does not change too rapidly during schema building operations. In some cases, documents that are a subset or superset of each other may be considered identical for purposes of the similarity index calculation. This property allows schema growth that would be expected to happen naturally over time to avoid impacting the index. For example, if a first document has keys {a, b} and a second document has keys {a, b, c}, the first document is a subset of the second document, and the second document is a superset of the first document. In such cases, the documents may be treated as identical for similarity index purposes.

In further embodiments, the system may implement a stability_limit threshold value. According to one example, the stability_limit threshold may be set to 0.8. When the Jaccard index falls below the stability_limit threshold after a specified number of union operations, the system may determine that the schema is unstable. In some implementations, a Schema Builder Component may return Document::any ( ) when the Jaccard index falls below the stability_limit after 5 or more unions, indicating an unstable schema. The Document::any ( ) return value indicates that the schema cannot be reliably determined due to excessive variability in document structures.

According to various embodiments, the system may be configured to ignore the similarity index for initial iterations of schema computation. In one example, the index may be ignored entirely for the first 5 iterations. In other examples, different threshold numbers of iterations may be used, such as 2, 3, 4, or 6 iterations. This approach provides tolerance for initial schema changes and yields an easing effect so that the first iterations of schema computation are tolerant of change. The approach may gradually become less tolerant of change over subsequent iterations.

The combination of the stability_limit threshold and the initial iteration tolerance provides a mechanism to prevent runaway querying. Without such safeguards, documents that are wildly different (for example, documents with 100 unique keys each) would cause the query operation to query for every document in the collection. By monitoring the Jaccard index and terminating schema building when the index indicates excessive instability, the system may avoid consuming inappropriate amounts of computational resources.

According to various embodiments, a system, method, or user interface may be configured to generate a schema on views of source data having a dynamic schema architecture. Schema computation for views can be implemented differently than for collections due to structural differences between views and collections in dynamic schema databases.

In some implementations, views may lack an Lid field that is present in collections. In a MongoDB implementation, for example, the Lid field is permitted to be absent in views but is present in collections. Without the \_id field, there may be no way to generate partitions in a stable manner that would be applicable to all view shapes. Accordingly, the partitioning approach used for collections may not be suitable for views.

According to some embodiments, a schema builder component may differentiate views from data collections by modifying a list_collections native function and introducing a helper function to separate views from collections. In one example, a CollectionInfo struct may be implemented with a views vector and a collections vector for separating namespace types during processing. The CollectionInfo struct may be defined as follows:

```
struct CollectionInfo {
  views: Vec,
  collections: Vec,
}
```

In further embodiments, a CollectionDoc struct may be implemented with name, type\, and options fields including view_on and pipeline for view definitions. The type\_field may indicate whether a namespace is a collection or a view, enabling the system to route processing accordingly.

According to various embodiments, a NamespaceType enum may be implemented distinguishing between Collection and View namespace types. The NamespaceType enum may be defined as:

```
pub enum NamespaceType {
  Collection,
  View,
}
```

This enumeration allows the schema builder component to track and communicate the type of namespace for which a schema has been generated.

In some embodiments, the schema builder component may process views by $sampling the source collection and executing the view pipeline. Unlike collections, which can be fully analyzed via the partition-method, views may be processed by randomly selecting a number of documents from the source collection. According to various embodiments, a sample size of 1000 documents may be used. In other examples, different sample sizes can be employed (e.g., 250, 500, 750, 1500, etc.).

According to some embodiments, a derivel_schemal_for_view function may be implemented that prepends a $sample stage to the view pipeline and iterates through sampled documents. The $sample stage randomly selects the specified number of documents from the source collection before the view pipeline is executed. The schema builder component may then compute the schema for each sampled document and merge the schemas together to produce a schema for the view.

In further embodiments, the schema builder component may derive schema for views from the view pipeline and a catalog of known schemas for other collections rather than partitioning. Because views are defined by aggregation pipelines that transform data from source collections, the schema of a view can be inferred by analyzing the pipeline stages and applying transformations to the known schemas of the source collections. This approach may reduce the computational burden of sampling in some cases.

According to various embodiments, when processing views, the system may execute the view pipeline against the sampled documents to produce output documents. The schema for each output document may be computed and merged with an existing schema using a union operation. The union operation may be additive for properties and reductive for required fields, as described for collection schema computation. The resulting schema may represent the structure of documents that the view produces.

According to various embodiments, a schema builder component implements asynchronous execution for I/O operations and leverages multiple CPU cores for processing. The schema builder component may use a tokio runtime library for asynchronous execution. The tokio runtime library provides an asynchronous task executor that enables non-blocking I/O operations, allowing the schema builder component to perform database queries and schema updates without blocking the execution thread while waiting for responses.

In some cases, the schema builder component uses a rayon crate for parallel iterators and a tokio crate for asynchronous execution, including channels used for notifications. The rayon crate provides data parallelism primitives that enable parallel iteration over collections of data, while the tokio crate provides the asynchronous runtime and communication channels for coordinating between tasks and sending notifications to callers.

According to some embodiments, the schema builder component spawns parallel async tasks for each database, and within those tasks for each collection, and within those tasks for each partition using tokio::spawn. The tokio::spawn function creates a new asynchronous task that begins executing immediately in the background while returning a JoinHandle that can be used to await the task's completion. This approach enables the schema builder component to process multiple databases concurrently, and within each database to process multiple collections concurrently, and within each collection to process multiple partitions concurrently.

In further embodiments, the schema builder component uses future::join_all to await all database task JoinHandles and iterate through results to report any errors. The future::join_all function takes a collection of futures (such as JoinHandles returned by tokio::spawn) and returns a single future that completes when all of the input futures have completed. The schema builder component may then iterate through the results of each completed task to identify and report any errors that occurred during schema computation.

According to some embodiments, the schema builder component uses an Arc>data structure to store initial schemas, allowing concurrent access across all tasks with free clones. The Arc (Atomically Reference Counted) wrapper enables multiple ownership of the data structure across different tasks, while the RwLock (Read-Write Lock) provides thread-safe access that allows multiple concurrent readers or a single writer. This data structure enables the schema builder component to share initial schema information across all parallel tasks without requiring expensive data copying operations.

In various implementations, the schema builder component implements a process_collections function and a process_views function that spawn parallel async tasks for each collection and each view respectively. The process_collections function iterates through the collections in a database and spawns a separate async task for each collection to compute the collection's schema. Similarly, the process_views function iterates through the views in a database and spawns a separate async task for each view to compute the view's schema. This separation allows the schema builder component to handle the different processing requirements of collections and views while maintaining parallel execution.

According to further embodiments, the schema builder component implements a derive_schema_for_partitions function that parallelizes schema derivation per partition and unions results. The derive_schema_for_partitions function receives a collection of partitions and spawns a parallel task for each partition to derive the schema for that partition. Once all partition tasks have completed, the function unions the resulting schemas from each partition together to produce a complete schema for the entire collection. This approach enables the schema builder component to process large collections efficiently by dividing the work across multiple partitions that can be processed in parallel.

According to various embodiments, the schema builder component implements a notification system configured to send activity messages and status updates to callers through communication channels. In some examples, tokio channels are used to transmit notifications during schema building operations. The notification system may provide visibility into the progress and state of schema construction across databases, collections, and views.

In some implementations, a SamplerNotification struct is defined to represent notification messages. The SamplerNotification struct may include a db field representing the name of the database being processed, a collection_or\_view field representing the name of the collection or view for which schema operations are being performed, and an action field representing the type of action being communicated. The action field may contain a value from a SamplerAction enum that defines the various notification types supported by the system.

According to various embodiments, the SamplerAction enum includes multiple variants to represent different stages and events during schema building operations. A Querying variant may be used to indicate that the builder is issuing a query to find documents that do not match a current schema. A Processing variant may be used to indicate that the builder is performing schema merge operations after a query returns results. A Partitioning variant may be used to indicate that the builder is calculating partitions for a collection. An UsingInitialSchema variant may be used to indicate that the builder is leveraging an existing schema as a seed for schema computation. A Warning variant may be used to communicate non-fatal issues encountered during schema building. An Error variant may be used to communicate errors that occur during builder operations after the builder has begun work. A Sampling View variant may be used to indicate that the builder is sampling a view to compute the view schema.

In further embodiments, a notify! macro is implemented to facilitate sending notifications and logging. The notify! macro may be configured to send notifications over the provided tokio channels and log messages at appropriate levels based on the action type. For example, error actions may be logged at an error level, warning actions may be logged at a warning level, and other actions such as querying, processing, and partitioning may be logged at a debug or trace level. The notify! macro may accept parameters including the notification channel, the database name, the collection or view name, and the action to be communicated. The macro may construct a SamplerNotification struct from the provided parameters and transmit the notification over the channel while simultaneously logging the action according to the configured logging level.

According to various embodiments, a schema builder component includes a mechanism to ignore system collections that should not be analyzed during schema building operations. The schema builder component may utilize a DISALLOWED_DB_NAMES array that specifies databases to be excluded from schema analysis. In some implementations, the DISALLOWED_DB_NAMES array contains database names including “admin”, “config”, “local”, and “system”. When the schema builder component encounters a database name that matches any entry in the DISALLOWED_DB_NAMES array, the schema builder component may skip analysis of that database and proceed to the next database in the enumeration.

In further embodiments, the schema builder component implements a DISALLOWED_COLLECTION_NAMES array that specifies collection names to be excluded from schema analysis. The DISALLOWED_COLLECTION_NAMES array may contain collection name prefixes or exact collection names that should be ignored. In some implementations, the DISALLOWED_COLLECTION_NAMES array contains entries such as “system.namespaces”, “system.indexes”, “system.profile”, “system.js”, “system.views”, and “_sql_schemas”. Collections having names that match or start with any entry in the DISALLOWED_COLLECTION_NAMES array may be filtered out from schema building operations.

According to some embodiments, the schema builder component supports inclusion/exclusion specification using glob patterns or exact enumeration to match namespaces that should be included or excluded from schema analysis. Glob patterns may include wildcard characters that match multiple namespaces according to pattern matching rules. For example, a glob pattern such as “db1.” may match all collections within a database named “db1”. Exact enumeration may specify individual namespace identifiers such as “db1.collection1” to include or exclude specific collections from analysis.

In various implementations, the schema builder component implements a should_consider function that filters collections based on multiple criteria. The should_consider function may evaluate a namespace against an include_list, an exclude_list, and the DISALLOWED_COLLECTION_NAMES array. When an include_list is specified, the should_consider function may test whether the namespace matches any element in the include_list. If the namespace does not match any element in the include_list, the should_consider function may return a result indicating that the namespace should not be considered for schema analysis.

When an exclude_list is specified, the should_consider function may test whether the namespace matches any element in the exclude_list. If the namespace matches any element in the exclude_list, the should_consider function may return a result indicating that the namespace should not be considered for schema analysis. The should_consider function may also test the namespace against the DISALLOWED_COLLECTION_NAMES array to filter out system collections regardless of the include_list and exclude_list specifications.

According to further embodiments, the filtering operations performed by the should_consider function occur in a streaming fashion for each element in the database and collection list. The streaming approach may reduce memory consumption by avoiding storage of complete namespace lists before filtering. Each namespace may be evaluated against the filtering criteria as the namespace is encountered during enumeration of databases and collections.

In some implementations, the schema builder component supports a dry run mode that outputs a list of collections and views that would be analyzed without performing actual schema analysis. When a user specifies a dry_run option via a command line interface or other interface mechanism, the schema builder component may enumerate databases and collections, apply the filtering criteria using the should_consider function, and output the resulting list of namespaces that would be subject to schema building operations. The dry run mode may aid users in configuring inclusion and exclusion lists by providing visibility into which namespaces would be affected by the specified filtering criteria. The dry run mode may perform no further analysis beyond outputting the filtered namespace list, thereby conserving computational resources during configuration and testing of filtering parameters.

According to various embodiments, schema unioning operations are implemented as additive for properties and reductive for required data. When two document schemas are combined, the resulting schema includes all properties from both source schemas, while the required fields are reduced to include only those fields that appear as required in both source schemas. This approach ensures that the union schema can match documents conforming to either of the original schemas.

A document_union function may be implemented to union two document schemas. The document_union function receives two document schema inputs and produces a single document schema output. The document_union function adds properties from both input schemas to the output schema, such that any property appearing in either input schema appears in the output schema. For required fields, the document_union function computes the intersection of the required field sets from both input schemas, such that only fields marked as required in both input schemas are marked as required in the output schema.

To support document schema operations, various helper functions may be implemented. A union\_keys helper function may be implemented for Document key map operations. The union\_keys helper function receives two key maps and produces a combined key map containing all keys from both input maps. When a key appears in both input maps, the union\_keys helper function may combine the associated schema values using a schema union operation.

An intersect\_keys helper function may be implemented for Document key map operations. The intersect\_keys helper function receives two key sets and produces a key set containing only keys that appear in both input sets. The intersect\_keys helper function may be used to compute the required field set for a unioned document schema.

A retain\ keys helper function may be implemented for Document key map operations. The retain\_keys helper function receives a key map and a set of keys to retain, and produces a key map containing only the specified keys. The retain\ keys helper function may be used to filter document properties during schema operations.

To support schema representation and operations, a Schema enum may be implemented with multiple variants. An Unsat variant represents an unsatisfiable schema that matches no documents. A Missing variant represents a schema for fields that are absent from a document. An Atomic variant represents schemas for atomic BSON types such as String, Integer, Boolean, Double, Decimal, ObjectId, Date, Timestamp, BinData, Null, Regex, Javascript, JavascriptWithScope, DbPointer, Symbol, MinKey, and MaxKey. An Array variant represents schemas for array values, where the Array variant contains a nested schema describing the array element types. A Document variant represents schemas for document values, where the Document variant contains a key map of field names to field schemas, a set of required field names, and an additional\_properties flag indicating whether unlisted fields are permitted. An AnyOf variant represents schemas that match any of multiple possible schemas, where the AnyOf variant contains a set of schema alternatives. An Any variant represents a schema that matches any value.

The Schema enum variants support schema union operations through pattern matching. When unioning two Atomic variants with the same atomic type, the result is that same Atomic variant. When unioning two Atomic variants with different atomic types, the result may be an AnyOf variant containing both atomic types. When unioning two Document variants, the document_union function may be invoked to combine the document schemas. When unioning two Array variants, the nested element schemas may be unioned recursively. When unioning any schema with an Any variant, the result is the Any variant. When unioning any schema with an Unsat variant, the result is the other schema. When unioning schemas of incompatible types, the result may be an AnyOf variant containing both schemas.

According to various embodiments, jsonSchema representations are computed for documents by examining fields and values within each document to create type definitions. A schema\_for_document derivation function may be configured to analyze a bson::Document and produce a corresponding schema::Document representation. In some cases, an empty bson::Document produces a schema::Document with no keys, no required fields, and additional\_properties set to false. A single-element bson::Document may produce a schema::Document with the single key, requiring that key, and additional\_properties set to false. A multi-element bson::Document may produce a schema::Document with all of the keys, marking all as required, and additional\_properties set to false.

In various implementations, a schemal for\ bson function may provide a mapping between Bson types and Schema::Atomic types. For example, the function may map bson string values to Schema::Atomic (String), bson boolean values to Schema::Atomic (Boolean), and bson numeric values to corresponding numeric atomic types such as Schema::Atomic (Integer), Schema::Atomic (Long), Schema::Atomic (Double), or Schema::Atomic (Decimal). In some cases, the mapping is a direct correspondence between Bson type variants and Schema::Atomic type variants.

According to some embodiments, a schema\_for_bson\_array function may be configured to derive schema representations for array elements. An empty bson::Bson array may produce a schema::Array of schema::Any. A single-element bson::Bson array may produce a schema::Array of that single element's schema. A multi-element bson::Bson array where every element has the same schema may produce a schema::Array with that single schema. A multi-element bson::Bson array where each element has a different schema may produce a schema::Array with the union of all element schemas.

In further embodiments, a schema builder component may implement TryFrom trait conversions between json\ schema::Schema and an internal Schema representation for interoperability. The TryFrom trait implementation may enable conversion from a json\_schema::Schema type to the internal Schema type used by the schema builder. In some cases, the conversion may handle various json\_schema constructs including object types, array types, atomic types, and anyOf constructs. The TryFrom implementation may return an error when encountering unsupported or invalid json\_schema constructs that cannot be represented in the internal Schema format.

According to various embodiments, the schema builder component may convert between the internal Schema representation and bson::Document format for storage and retrieval from a database such as MongoDB. In some cases, a Schema may be serialized to a bson::Document for storage in a schema collection within the database. The serialization may preserve type information, property definitions, required field lists, and additional\_properties settings. In other cases, a bson::Document retrieved from the schema collection may be deserialized back into the internal Schema representation for use during schema building operations.

In some implementations, the conversion to bson::Document format may follow jsonSchema conventions, where object types include a “bsonType” field set to “object”, a “properties” field containing nested type definitions for each document field, a “required” array listing fields that appear in all documents, and an “additionalProperties” field indicating whether unlisted fields are permitted. Array types may include a “bsonType” field set to “array” and an “items” field containing the schema for array elements. Atomic types may include a “bsonType” field set to the corresponding type name such as “string”, “int”, “long”, “double”, “decimal”, “bool”, “objectId”, “date”, “timestamp”, “binData”, “null”, “regex”, “javascript”, “javascript WithScope”, “minKey”, “maxKey”, “dbPointer”, “symbol”, or “undefined”.

According to some embodiments, the conversion from bson::Document format back to the internal Schema representation may parse the “bsonType” field to determine the schema type and recursively process nested structures. In some cases, an anyOf construct in the bson::Document may be converted to a Schema::AnyOf containing a set of the constituent schemas. The conversion may handle missing or optional fields by applying default values where appropriate.

According to various embodiments, the schema builder component implements data structures for representing and managing schema information in dynamic schema databases. A Document struct may be used to represent document schemas, where the Document struct includes a keys field implemented as a BTreeMap that maps field names (as strings) to their corresponding schema types. The Document struct may also include a required field implemented as a BTreeSet that contains the names of fields that appear in every document conforming to the schema. An additional\_properties field implemented as a boolean indicates whether the document may contain fields beyond those explicitly defined in the keys map. In some cases, the Document struct may include an optional jaccard\_index field that stores a set similarity index value used during schema building operations to detect schema instability and prevent runaway querying.

According to various embodiments, the schema builder component implements an Atomic enum with 19 BSON type variants to represent atomic (non-composite) data types. The Atomic enum variants may include MinKey, MaxKey, Null, Undefined, Integer, Long, Double, Decimal, String, Boolean, Date, ObjectId, BinData, Regex, DbPointer, Javascript, JavascriptWithScope, Symbol, and Timestamp. Each variant of the Atomic enum corresponds to a BSON type that may appear in documents stored in a dynamic schema database such as MongoDB. The Atomic enum enables the schema builder component to precisely represent the types of values that may appear in document fields.

According to various embodiments, the schema builder component implements lazy\_static definitions for common schema patterns that are reused throughout schema building and validation operations. An ANY\ DOCUMENT schema pattern may be defined as a Document with an empty keys map, an empty required set, and additional\_properties set to true, representing a document that may contain any fields of any types. An EMPTY\ DOCUMENT schema pattern may be defined as a Document with an empty keys map, an empty required set, and additional\_properties set to false, representing a document that contains no fields. An ANY\_ARRAY schema pattern may be defined as an Array containing the Any schema type, representing an array that may contain elements of any type. An EMPTY\_ARRAY schema pattern may be defined as an Array containing the Unsat schema type, representing an array with no valid element types. A NULLISH schema pattern may be defined as an AnyOf containing Atomic (Null) and Missing, representing values that may be either null or absent. A NUMERIC schema pattern may be defined as an AnyOf containing Atomic (Integer), Atomic (Long), Atomic (Double), and Atomic (Decimal), representing values that may be any numeric BSON type.

According to various embodiments, the schema builder component implements a SchemaEnvironment struct using a BindingTuple for managing datasource-schema key-value pairs. The SchemaEnvironment struct wraps a BindingTuple parameterized with Schema types, enabling the system to associate datasource identifiers with their corresponding schema definitions. The SchemaEnvironment struct may implement union operations that combine schema information from multiple datasources, where duplicate datasource keys result in the schema values being bundled in an AnyOf schema type. The SchemaEnvironment struct may provide methods for inserting, removing, and retrieving schema information by datasource key, as well as methods for merging multiple SchemaEnvironment instances and checking for field name collisions across datasources.

According to various embodiments, the schema builder component implements a ResultSet struct for representing query result set schema information. The ResultSet struct may contain a schema\_env field that stores a SchemaEnvironment representing the schema of the result set. The ResultSet struct may also contain a min\_size field indicating the minimum number of rows that may be returned by a query, and a max\ size field indicating the maximum number of rows that may be returned. The min\_size and max\_size fields enable the system to track cardinality information about query results, which may be used for query optimization and validation purposes.

According to various embodiments, schema operations can include satisfaction analysis to determine relationships between schemas and data elements. A Satisfaction enumeration may be implemented with three values: Must, May, and Not. The Must value indicates that a condition is satisfied in all cases. The May value indicates that a condition may be satisfied in some cases but not others. The Not value indicates that a condition is not satisfied in any case. These satisfaction values can be used throughout schema operations to express certainty levels regarding schema relationships and comparisons.

In some embodiments, a schema\_predicate\_meet function may be implemented for handling AnyOf schemas. An AnyOf schema represents a schema that can match any one of multiple possible schema definitions. The schemal_predicate\_meet function can evaluate predicates against AnyOf schemas by examining each constituent schema within the AnyOf set. The function may return a satisfaction value based on whether the predicate is satisfied by all, some, or none of the constituent schemas. For example, if a predicate is satisfied by all schemas in an AnyOf set, the function may return Must. If the predicate is satisfied by some but not all schemas, the function may return May. If the predicate is not satisfied by any schema in the set, the function may return Not.

According to further embodiments, a satisfies\_any_of function may be implemented to check whether a given schema satisfies any schema within an AnyOf set. The satisfies_any_of function can iterate through each schema in the AnyOf set and determine whether the input schema matches at least one of the constituent schemas. The function may return a satisfaction value indicating the degree to which the input schema satisfies the AnyOf schema definition.

In various implementations, an is\_comparablel_with function may be provided for determining whether two schemas can be compared in query operations. The is\_comparable\_with function can return a satisfaction value indicating whether values conforming to two schemas can be meaningfully compared. The function may implement special handling for numeric types, where different numeric types (e.g., integer, long, double, decimal) may be considered comparable with each other. For example, an integer schema may be comparable with a double schema because both represent numeric values that can be compared mathematically.

The is\_comparablel_with function may also implement special handling for null values. In some cases, null values may be comparable with other types for purposes of equality checking or sorting operations. The function can evaluate whether a schema that includes null values can be compared with another schema and return an appropriate satisfaction value. For schemas that include multiple possible types (e.g., an AnyOf schema containing both integer and string types), the is\_comparable\_with function may return May to indicate that comparison is possible in some cases but not others.

According to some embodiments, a contains\_field function may be implemented to determine whether a schema contains a specified field. The contains\_field function can accept a schema and a field name as inputs and return a satisfaction value of Must, May, or Not. The function may return Must when the schema is a document schema that includes the specified field in its required fields set. The function may return May when the schema is a document schema that includes the specified field in its properties but the field is not in the required set, or when the schema has additional\_properties set to true. The function may return Not when the schema is a document schema that does not include the specified field and has additional\_properties set to false, or when the schema is not a document type (e.g., an atomic type or array type).

For AnyOf schemas, the contains\_field function may evaluate each constituent schema and aggregate the results. If all constituent schemas return Must for containing the field, the function may return Must. If at least one constituent schema returns Must or May but not all return Must, the function may return May. If all constituent schemas return Not, the function may return Not. This aggregation approach allows the contains\_field function to provide accurate satisfaction values for complex schema definitions that include multiple possible document shapes.

According to various embodiments, a schema builder component may implement schema simplification and transformation operations to process and refine schema definitions for dynamic schema databases. These operations may include simplification of nested structures, handling of missing and null types, field path enumeration, and collision detection across datasources.

In some cases, the schema builder component may implement a simplify operation that processes schema definitions to remove redundant or nested structures. For example, nested AnyOf structures may be flattened so that an AnyOf containing another AnyOf results in a single AnyOf with all constituent schema types combined. The simplify operation may also remove duplicate schema entries within an AnyOf, ensuring that identical schema types appear only once. When an AnyOf contains only a single schema type after simplification, the AnyOf wrapper may be removed and the single schema type may be returned directly. An empty AnyOf may be simplified to an Unsat schema indicating no valid schema exists.

According to some embodiments, the simplify operation may handle Missing types within document schemas. When a document schema contains fields with Missing type, the simplify operation may remove those fields from the keys of the document and remove those field names from the required set. For nested documents, the simplify operation may recursively process inner document schemas to handle Missing types at all levels of nesting. This approach ensures that the resulting schema accurately reflects which fields may or may not be present in matching documents.

In further embodiments, the schema builder component may implement a subtract_nullish operation that removes Null and Missing from schemas. The subtract_nullish operation may process a schema and return a modified schema that does not satisfy nullish types. For an AnyOf schema containing Atomic (Null) or Missing along with other types, the subtract_nullish operation may return an AnyOf containing only the non-nullish types. When applied to a schema consisting only of Atomic (Null), the subtract_nullish operation may return Unsat since no non-nullish type remains. For an Any schema, the subtract_nullish operation may return an AnyOf containing all atomic types except Null, along with Array and Document types, but excluding Missing.

According to various embodiments, the schema builder component may implement an upconvert_missing_to_null operation for array items schemas. In array contexts, Missing is not a valid type for array items since array elements are either present with a value or the array does not contain that element. The upconvert_missing_to_null operation may convert Missing types within array item schemas to Null types, ensuring that the resulting schema accurately represents the possible types of array elements.

In some cases, the schema builder component may implement an enumerate_field_paths function that exhaustively enumerates all field paths up to a maximum length for schemas. The enumerate_field_paths function may accept a schema and an optional maximum length parameter and return a set of field paths along with a boolean indicating whether all matched values are documents. For Atomic, Array, Unsat, and Missing schemas, the enumerate_field_paths function may return an empty set of field paths since these schema types do not contain named fields. For Document schemas without additional_properties set to true, the enumerate_field_paths function may recursively enumerate all field paths through nested document structures. When additional_properties is true, the enumerate_field_paths function may return an error indicating that all field paths cannot be enumerated since unknown fields may exist. For AnyOf schemas, the enumerate_field_paths function may combine field paths from all constituent document schemas. The maximum length parameter may limit the depth of enumeration, returning only field paths up to the specified length.

According to some embodiments, the schema builder component may implement a check_for_non_namespaced_collisions function that detects duplicate field names across datasources within a schema environment. The check_for_non_namespaced_collisions function may iterate through all datasource-schema pairs in the schema environment and collect field names from each schema. When a field name appears in multiple datasources, the function may record the duplicate field name and the datasources containing that field. If any duplicate field names are detected, the check_for_non_namespaced_collisions function may return an error containing a list of conflicting field names and the schemas from datasources with duplicates. The error message may suggest aliasing the conflicting fields to unique names. If a schema has additional_properties set to true, the check_for_non_namespaced_collisions function may return an error indicating that all field paths cannot be enumerated for that schema.

In further embodiments, the schema builder component may implement get_single_field_name_and_schema function that returns a field name and schema if every matched value is a document containing a single field. For Document schemas with exactly one key in the keys map, no additional_properties, and either zero or one required field, the get_single_field_name_and_schema function may return the field name and its associated schema. For AnyOf schemas, the function may check whether all constituent document schemas have the same single field name; if so, the function may return that field name along with an AnyOf of the field schemas from each constituent document. When schemas contain Unsat, those schemas may be ignored in the analysis. For schemas that do not represent single-field documents, including Any, Missing, Atomic, Array, empty documents, or documents with multiple fields or additional_properties, the get_single_field_name_and_schema function may return None.

According to various embodiments, the schema builder component may implement a has_overlapping_keys_with function that determines if two document schemas may, must, or must not have overlapping keys. The has_overlapping_keys_with function may compare the keys of two Document schemas and return a satisfaction indicator. When both documents have at least one required key in common, the function may return Must indicating that overlapping keys are guaranteed. When the documents have keys in common but none are required in both, the function may return May indicating that overlapping keys are possible but not guaranteed. When the documents have no keys in common and neither has additional_properties set to true, the function may return Not indicating that overlapping keys are not possible.

In some cases, the schema builder component may implement a num_keys function on Document schemas that returns minimum and maximum numbers of keys a matching document could contain. The minimum number of keys may be determined by the count of required fields in the document schema. The maximum number of keys may be determined by the total count of keys in the keys map when additional properties is false, or may be unbounded when additional_properties is true. This information may be used during schema analysis to determine bounds on document structure.

According to various embodiments, the schema builder component may implement query execution operations using a $jsonSchema query operator to identify documents that do not match a current schema definition. The $jsonSchema query operator is a MongoDB query operator that validates documents against a JSON Schema specification. In the context of schema building, the $jsonSchema operator may be used within a $nor clause to find documents that do not conform to an existing computed schema. By negating the schema match condition, the query returns documents having properties or field types not yet captured in the schema definition.

In some examples, a generatel_partition\_match function may be configured to create a $match aggregation stage containing a $nor clause. The $nor clause may include the $jsonSchema operator with the current schema definition as the schema to match against. When executed, the aggregation pipeline returns documents that fail to match the specified schema, thereby identifying source data units having attributes that should be incorporated into the schema. The generate\_partition\_match function may accept an optional schema parameter. When the schema parameter is None, the function may produce a match document without a schema predicate. When the schema parameter is Some, the function may produce a match document containing the $jsonSchema predicate within the $nor clause.

According to further embodiments, an ignored\_ids exclusion list may be maintained during query execution. The ignored\ ids list may contain identifiers of documents that have already been processed during schema building iterations. By excluding previously processed document identifiers from subsequent queries, the system may avoid redundant processing of the same documents across multiple iterations. The ignored\ ids list may be incorporated into the $match stage to filter out documents that have already contributed their attributes to the schema definition.

In various implementations, AggregateOptions may be configured with an Lid index hint optimization. The Lid index hint may direct the database query engine to use the \_id index when executing aggregation operations. Since MongoDB collections have an index on the Lid field by default, hinting the Lid index may improve query performance during partition-based schema computation. The index hint may be specified as part of the aggregation options passed to the database driver when executing queries to find non-matching documents.

According to some embodiments, a derive\_schema\_for_partition function may be implemented as an iterative function for computing the schema of a single partition. The derivel_schema\_for\_partition function may accept a partition definition and an optional initial schema as input parameters. The function may execute a loop that repeatedly issues queries for documents not matching the current schema, computes the schema for each returned document, and merges the computed schema with the existing schema. The loop may continue until no documents are returned from the query, indicating that all documents within the partition conform to the current schema definition. The derive\_schema\_for_partition function may return the computed schema for the partition upon completion.

In further embodiments, a derivel_schema\_for\_partitions function may be implemented as a parallel function for computing schemas across multiple partitions concurrently. The derive\_schema\_for_partitions function may spawn asynchronous tasks for each partition, with each task executing the derivel_schema\_for_partition function independently. The parallel execution may leverage multiple CPU cores to process partitions simultaneously, reducing the overall time for schema computation on large collections. Upon completion of all partition tasks, the derivel schema\_for_partitions function may union the schemas from each partition to produce a complete schema for the collection.

According to various embodiments, the schema builder component may implement a SchemaResult enum for communicating results to callers. The SchemaResult enum may include a NamespaceOnly variant and a FullSchema variant. The NamespaceOnly variant may be used in dry\_run mode, where the schema builder outputs a list of collections and views that would be analyzed without performing actual schema computation. The NamespaceOnly variant may contain namespace information including the database name, collection or view name, and namespace type. The FullSchema variant may contain namespace information along with the computed schema for the namespace. The FullSchema variant may be used when schema computation is performed and the resulting schema should be communicated to the caller. The SchemaResult enum may be sent over communication channels to provide results asynchronously as schema computation completes for each collection or view.

According to various embodiments, the schema builder component implements instrumentation using a tracing function with an [instrument] directive that provides addition of tracing spans to functions. A function annotated with [instrument] creates and enters a span with that function's name when the function is called, with arguments to that function recorded as fields using fmt::Debug. In some cases, the schema builder component sets a derivel_schema\ for\_partition function at a TRACE level while all other functions are set at a DEBUG level for logging purposes. Functions that are called repeatedly, such as derivel_schema\_for\_partition, may be set at the TRACE level to provide granular visibility into iterative operations without overwhelming log output during normal operation. The DEBUG level may be applied to functions that are called less frequently or that represent higher-level operations in the schema building process.

According to some embodiments, the schema builder component implements a Verbosity enum with Trace, Debug, Info, Warn, and Error variants for log level configuration. The Verbosity enum may allow callers to specify a desired logging verbosity when invoking schema builder operations. In some cases, the Trace variant provides the most detailed logging output, capturing information from functions instrumented at the TRACE level. The Debug variant may capture logging from functions instrumented at the DEBUG level and above. The Info, Warn, and Error variants may progressively filter logging output to show less detailed information, with the Error variant showing error conditions. Callers to the builder library may be responsible for capturing events and logging them as appropriate based on the configured verbosity level.

According to further embodiments, the schema builder component implements an Error enum with variants including JsonSchemaFailure, BsonFailure, NoCollectionStats, NoBounds, EmptyCollection, and others. The JsonSchemaFailure variant may indicate a failure related to JSON schema processing or validation during schema computation. The BsonFailure variant may indicate an error encountered when processing BSON data types or converting between BSON and schema representations. The NoCollectionStats variant may indicate that collection statistics could not be retrieved, which may affect partitioning decisions during schema building. The NoBounds variant may indicate that partition bounds could not be determined for a collection, which may occur when attempting to partition collections for parallel processing. The EmptyCollection variant may indicate that a collection contains no documents, in which case schema computation may produce an empty or default schema. In some cases, error action messages are sent whenever there is an error during builder operations after the builder has begun work. Error action messages may not be sent if there are initial errors, such as bad username/password or no primary found. The Error enum variants may be communicated to callers through notification channels or returned as part of result types to enable appropriate error handling by consuming applications.

According to various embodiments, the schema builder system may implement a command line interface (CLI) for accepting user input and configuration parameters. In some examples, a Cli struct may be defined with clap Parser derive for command line argument parsing and serde for configuration file support. The clap Parser derive enables automatic parsing of command line arguments into structured data, while serde enables serialization and deserialization of configuration data from files such as YAML or JSON configuration files.

In some implementations, the CLI may support a configuration merging function that combines settings from multiple sources. For example, the CLI config merging function may accept configuration parameters from a configuration file and override those parameters with any command line arguments explicitly provided by the user. This approach allows users to define default settings in a configuration file while selectively overriding specific parameters via command line arguments when executing the schema builder.

According to some embodiments, a SchemaAction enum may be defined with Overwrite and Merge variants. The Overwrite variant may indicate that any existing schema for a target collection or view should be replaced with a newly computed schema. The Merge variant may indicate that a newly computed schema should be combined with any existing schema for the target, preserving schema information from both sources. The SchemaAction enum may be specified as a command line argument or configuration file parameter to control how the schema builder handles existing schema data.

In various implementations, a SchemaDocument struct may be defined for storing schema information in a database. The SchemaDocument struct may include an id field for identifying the schema document, a namespace_type field for indicating whether the schema corresponds to a collection or a view, a schema field for storing the actual schema definition, and a last_updated field for recording when the schema was last modified. The SchemaDocument struct may be serialized to JSON or BSON format for storage in a schema collection within the database.

According to further embodiments, a SchemaBuilderResult enum may be defined for reporting schema update outcomes. The SchemaBuilderResult enum may include a Created variant indicating that a new schema was created for a namespace that did not previously have schema information. The SchemaBuilderResult enum may include an Error variant indicating that an error occurred during schema computation or storage. The SchemaBuilderResult enum may include a Modified variant indicating that an existing schema was updated with new schema information. The SchemaBuilderResult enum may include an Unchanged variant indicating that the computed schema matched the existing schema and no update was performed. The SchemaBuilderResult enum may be returned by schema builder functions or sent over communication channels to inform callers of the outcome of schema building operations for each namespace processed.

According to various embodiments, the schema builder component may support multiple authentication mechanisms for connecting to dynamic schema databases. In some examples, the schema builder component may support SCRAM-SHA-1 authentication, which allows connecting with username and password protected using SCRAM-SHA-1. For SCRAM-SHA-1 authentication, the mechanism may be set to “SCRAM-SHA-1”, the username may be specified and non-zero length, the password may be specified, and the source may be specified and defaults to the database name if supplied on the connection string or admin. In other examples, the schema builder component may support SCRAM-SHA-256 authentication, which allows connecting with username and password protected using SCRAM-SHA-256. For SCRAM-SHA-256 authentication, the mechanism may be set to “SCRAM-SHA-256”, the username may be specified and non-zero length, the password may be specified, and the source may be specified and defaults to the database name if supplied on the connection string or admin.

In further embodiments, the schema builder component may support MONGODB-X509 authentication, which allows connecting via an x509 certificate. For MONGODB-X509 authentication, the mechanism may be set to “MONGODB-X509”, the username may not be provided for MongoDB 3.4+but may be specified and non-zero length for MongoDB prior to 3.4, the password may not be specified, and the source may be $external and defaults to $external. In still other embodiments, the schema builder component may support MONGODB-AWS authentication. For MONGODB-AWS authentication, the mechanism may be set to “MONGODB-AWS”, the username may be specified as the non-sensitive AWS access key, the password may be specified as the sensitive AWS secret key, the source may be $external and defaults to $external, and mechanism properties may include AWS_SESSION_TOKEN to allow the user to specify an AWS session token for authentication with temporary credentials.

According to some embodiments, the schema builder component may support MONGODB-OIDC authentication, which allows connecting via OpenID Connect access tokens. For MONGODB-OIDC authentication, the username may be specified and its meaning varies depending on the OIDC provider integration used, the source may be $external and defaults to $external, the password may not be specified, and the mechanism may be set to “MONGODB-OIDC”. Mechanism properties for MONGODB-OIDC may include ENVIRONMENT, which allows the user to specify the name of a built-in OIDC application environment integration to use to obtain Workload credentials, where the value may be one of “azure” or “gcp”. If ENVIRONMENT is not set, Workforce authentication may be assumed. Mechanism properties may also include TOKEN_RESOURCE, which specifies the URI of the target resource and may be set if ENVIRONMENT is set. In other embodiments, the schema builder component may support PLAIN (LDAP) authentication. For PLAIN authentication, the mechanism may be set to “PLAIN”, the username may be specified and non-zero length, the password may be specified, and the source may be specified and defaults to the database name if supplied on the connection string or $external.

According to various embodiments, the schema builder component may implement a conditionally_add_oidc_human_flow function that adds an OIDC human flow callback when no ENVIRONMENT property is set in the authentication mechanism properties. The conditionally_add_oidc_human_flow function may detect when Workforce authentication is being used based on the absence of the ENVIRONMENT property and may configure the appropriate callback for human-interactive OIDC authentication flows.

In some embodiments, the schema builder component may implement resolver options for DNS resolution. The resolver options may include cloudflare, google, and quad9 resolvers. A user may specify a resolver if DNS resolution fails or takes too long. The resolver option may be provided via command line arguments or configuration file settings. In one example, the resolver option may be specified as “—resolver cloudflare”, “—resolver google”, or “—resolver quad9” to select the corresponding DNS resolver for name resolution operations during database connection establishment.

According to further embodiments, the schema builder component may implement cluster type detection and verification. The schema builder component may implement a get_cluster_type function that queries buildInfo to determine the type of cluster being connected to. The get_cluster_type function may return a cluster type indicating whether the cluster is an AtlasDataFederation cluster, a Community cluster, or an Enterprise cluster. The cluster type determination may be based on information returned from the buildInfo query executed against the connected database.

In various embodiments, the schema builder component may implement a verify_cluster_type function that validates whether the connected cluster is supported for schema building operations. The verify_cluster_type function may return errors for unsupported cluster types. In some examples, the verify_cluster_type function may return an error when the cluster type is AtlasDataFederation, indicating that Atlas Data Federation clusters are not supported for schema building operations. In other examples, the verify_cluster_type function may return an error when the cluster type is Community, indicating that Community clusters are not supported for schema building operations. The verify_cluster_type function may allow schema building operations to proceed when the cluster type is Enterprise, indicating that Enterprise clusters are supported for schema building operations.

According to various embodiments, a schema builder component may use a progress bar with a spinner style from an indicatif crate for displaying progress during schema building operations. The indicatif crate is a library for the RUST programming language that provides progress bar and spinner functionality for command line applications. In some cases, the progress bar may be configured to display a spinner animation that indicates ongoing activity during schema computation, partitioning, querying, and schema update operations. The spinner style may provide visual feedback to users during long-running schema building operations, allowing users to observe that the system is actively processing data without requiring specific percentage completion information. In further embodiments, the progress bar may be updated as the schema builder transitions between different phases of operation, such as when partitioning collections, querying for non-matching documents, or merging schema definitions.

According to some embodiments, the schema builder component may implement a human\_panic setup with Metadata for generating crash reports with support contact information. The human\_panic crate is a library for the RUST programming language that provides user-friendly panic messages and crash report generation. In some cases, the Metadata structure may be configured to include support contact information, application name, version information, and other relevant details that may assist in diagnosing issues when unexpected errors occur during schema building operations. The human\ panic setup may generate crash reports that capture relevant diagnostic information while presenting users with a friendly message rather than raw panic output. In further embodiments, the crash reports may be written to a file location accessible to users, enabling users to share diagnostic information with support personnel when troubleshooting schema building failures.

According to various embodiments, the schema builder component may use serdel_stacker for deserializing deeply nested BSON documents that might otherwise cause stack overflow. The serdel_stacker crate is a library for the RUST programming language that provides stack overflow protection during deserialization of deeply nested data structures. In some cases, dynamic schema databases may contain documents with deep nesting levels that exceed default stack size limits during deserialization operations. The serdel_stacker library may be configured to move deserialization operations to the heap when stack depth exceeds a configurable threshold, thereby preventing stack overflow errors when processing deeply nested documents. In further embodiments, the schema builder may leverage serdel_stacker when computing schemas for documents with complex nested structures, ensuring that schema generation operations complete successfully regardless of document nesting depth. The use of serdel_stacker may enable the schema builder to handle a wider variety of document structures without encountering runtime failures due to stack exhaustion.

According to various embodiments, the schema builder component, query execution component, validation engine, and interface module operate in coordination to construct total schemas for dynamic schema databases. The schema builder component manages the overall schema construction process, including maintaining current schema definitions and orchestrating updates as new attributes are discovered. The query execution component executes queries against source data to identify documents that do not conform to a current schema definition. The validation engine evaluates schema completeness and determines when termination conditions have been satisfied. The interface module provides access points for users to initiate and control schema building operations.

In operation, the iterative workflow begins when the schema builder component receives an instruction to build a schema for a target grouping of source data. The schema builder component first identifies any initial schema that may exist for the target, such as a pre-defined schema, a sampled schema, or a user-submitted schema. If an initial schema exists, the schema builder component uses the initial schema as a seed for subsequent operations. If no initial schema exists, the schema builder component may generate a seed schema by analyzing a limited number of documents from the target grouping.

The schema builder component then triggers the query execution component to execute a query operation against the target grouping. The query operation is configured to identify source data documents that do not match the current schema definition. For example, the query execution component may execute a $jsonSchema query operator with a negation condition to find documents having properties not represented in the current schema. The query execution component returns any non-matching documents to the schema builder component.

Upon receiving non-matching documents, the schema builder component extracts attributes from the non-matching documents. The extracted attributes include field names, field types, and structural information such as nested document structures and array element types. The schema builder component then performs a union operation to merge the extracted attributes with the current schema definition. The union operation is additive for properties, meaning new fields discovered in non-matching documents are added to the schema definition. The union operation is reductive for required fields, meaning fields that do not appear in every document are removed from the required set while remaining in the properties definition.

The schema builder component then re-executes the query operation using the updated schema definition. Each iteration of the query operation analyzes fewer documents as the schema definition expands to encompass more document structures. The iterative process continues with the schema builder component repeatedly triggering query operations, extracting attributes from non-matching documents, and updating the schema definition through union operations.

The validation engine monitors the iterative process and evaluates termination conditions. In some cases, the validation engine determines that schema construction is complete when a query operation returns no non-matching documents, indicating that the current schema definition matches all documents in the target grouping. In other cases, the validation engine evaluates threshold conditions to determine when to terminate the iterative process. Threshold conditions may include a maximum number of documents processed, a maximum number of query iterations executed, or a similarity threshold value.

The validation engine may perform similarity analysis to evaluate schema stability during the iterative process. The similarity analysis compares successive schema definitions to detect rapid changes that may indicate schema instability. In some implementations, the Schema Builder Component implements an eq_with_jaccard_index function on Document for comparing documents including their jaccard_index fields. The eq_with_jaccard_index function enables the validation engine to compare document structures and determine whether documents are sufficiently similar to be considered conforming to a common schema pattern. The Jaccard index calculation considers the intersection of keys in two documents divided by the union of keys, providing a measure of structural similarity between documents.

When the validation engine determines that a termination condition has been satisfied, the schema builder component stores the final schema definition in association with the target grouping. The interface module may send notifications to indicate completion of schema construction and provide access to the constructed schema. The constructed total schema can then be used by other database operations, such as structured query execution under strongly typed execution parameters.

Additionally, an illustrative implementation of a special purpose computer system 200 that may be specially programmed to be used in connection with any of the embodiments of the disclosure provided herein is shown in FIG. 2. The computer system 200 may include one or more processors 210 and one or more articles of manufacture that comprise non-transitory computer-readable storage media (e.g., memory 220 and one or more non-volatile storage media 230). The processor 210 may control writing data to and reading data from the memory 220 and the non-volatile storage device 230 in any suitable manner. To perform any of the functionality described herein (e.g., secure execution, proxied execution, sandboxed execution, etc.), the processor 210 may execute one or more processor-executable instructions stored in one or more non-transitory computer-readable storage media (e.g., the memory 220), which may serve as non-transitory computer-readable storage media storing processor-executable instructions for execution by the processor 210.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A system for generating a schema representation in a dynamic schema database, the system comprising:
at least one processor operatively connected to a memory, the at least one processor when executing configured to:
identify any initial schema;
trigger a query operation to identify source data not matching the initial schema;
capture attributes from the documents not matching the initial schema;
generate a union of the initial schema and the attributes to generate an updated schema;
re-execute the query operation to identify source data not matching the updated version of a schema; and
validating the updated schema based on no results returned on a query operation to identify documents not matching the updated schema.

2. The system of claim 1, wherein the at least one processor is further configured to generate a set similarity index score based on an intersection of keys in two documents divided by a union of keys in the two documents, and manage execution of schema operations using a threshold value for the set similarity index score to prevent runaway querying.

3. The system of claim 2, wherein the at least one processor is further configured to determine that documents are a subset or superset of each other and treat the documents as identical for purposes of the set similarity index score calculation.

4. The system of claim 2, wherein the at least one processor is further configured to ignore the set similarity index score for a predetermined number of initial iterations of the query operation.

5. The system of claim 1, wherein the at least one processor is further configured to partition the target grouping of source data into a plurality of partitions and execute the query operation in parallel across the plurality of partitions.

6. The system of claim 5, wherein the at least one processor is further configured to union schema results from each partition of the plurality of partitions to produce a complete schema for the target grouping.

7. The system of claim 1, wherein the at least one processor is further configured to generate a schema on views of source data having a dynamic schema architecture by sampling a source collection and executing a view pipeline against sampled documents.

8. The system of claim 1, wherein the union operation is additive for properties such that new fields discovered in non-matching documents are added to the schema, and reductive for required fields such that fields not appearing in every document are removed from a required set while remaining in a properties definition.

9. The system of claim 1, wherein the at least one processor is further configured to execute the query operation using a $jsonSchema query operator with a negation condition to find documents having properties not represented in a current schema definition.

10. The system of claim 1, wherein the initial schema comprises at least one of a pre-defined schema, a sampled schema, or a user-submitted schema.

11. A computer implemented method for generating a schema representation in a dynamic schema database, the method comprising:
identifying, by at least one processor, any initial schema;
triggering a query operation to identify source data not matching the initial schema;
capture attributes from the documents not matching the initial schema and generate a union of the initial schema and the attributes;
re-execute the query operation to identify source data not matching an updated version of a schema; and
validating the updated schema based on no results returned on a recent query operation to identify documents not matching the updated schema.

12. The method of claim 11, further comprising generating a set similarity index score based on an intersection of keys in two documents divided by a union of keys in the two documents, and managing execution of schema operations using a threshold value for the set similarity index score to prevent runaway querying.

13. The method of claim 12, further comprising determining that documents are a subset or superset of each other and treating the documents as identical for purposes of the set similarity index score calculation.

14. The method of claim 11, further comprising partitioning the target grouping of source data into a plurality of partitions and executing the query operation in parallel across the plurality of partitions.

15. The method of claim 14, further comprising unioning schema results from each partition of the plurality of partitions to produce a complete schema for the target grouping.

16. The method of claim 11, wherein the union operation is additive for properties such that new fields discovered in non-matching documents are added to the schema, and reductive for required fields such that fields not appearing in every document are removed from a required set while remaining in a properties definition.

17. A non-transitory computer-readable storage medium storing processor-executable instructions that, when executed by at least one processor, cause the at least one processor to perform operations for generating a schema representation in a dynamic schema database, the operations comprising:
identifying an initial schema for a target grouping of source data in the dynamic schema database;
executing a query operation configured to identify source data documents not matching the initial schema;
capturing attributes from the source data documents not matching the initial schema;
generating an updated schema by performing a union operation of the initial schema and the captured attributes;
iteratively re-executing the query operation to identify source data documents not matching the updated schema and updating the schema based on attributes captured from non-matching documents; and
validating the updated schema based on a determination that no results are returned from a query operation to identify documents not matching the updated schema.

18. The non-transitory computer-readable storage medium of claim 17, wherein the operations further comprise generating a set similarity index score based on an intersection of keys in two documents divided by a union of keys in the two documents, and managing execution of schema operations using a threshold value for the set similarity index score to prevent runaway querying.

19. The non-transitory computer-readable storage medium of claim 18, wherein the operations further comprise determining that documents are a subset or superset of each other and treating the documents as identical for purposes of the set similarity index score calculation.

20. The non-transitory computer-readable storage medium of claim 17, wherein the operations further comprise partitioning the target grouping of source data into a plurality of partitions and executing the query operation in parallel across the plurality of partitions.
